(19) United States
(12) Patent Application Publication
(10) Pub. No.: US 2016/0107133 A1
(43) Pub. Date: Apr. 21, 2016

(54) MADE-TO-ORDER SYSTEM AND PREPARATION SYSTEM FOR COSMETICS

(71) Applicant: HEISHIN LTD., Hyogo (JP)

(72) Inventors: Yoshihiro SUGINO, Nagahama-shi (JP); Yumi NAKAGAWA, Kobe-shi (JP); Emi TOKUNAGA, Kobe-shi (JP)

(73) Assignee: HEISHIN LTD., Hyogo (JP)

(21) Appl. No.: 14/985,998

(22) Filed: Dec. 31, 2015

Related U.S. Application Data
(63) Continuation of application No. PCT/JP2014/003606, filed on Jul. 8, 2014.

(30) Foreign Application Priority Data
Jul. 9, 2013 (JP) 2013-144001
Dec. 11, 2013 (JP) 2013-256084
Feb. 14, 2014 (JP) 2014-026882

(51) Int. Cl. B01F 15/00; G05D 11/02; B05B 11/00; A45D 44/00; G01N 21/25

(52) U.S. Cl. CPC B01F 15/00214; A45D 44/005; G01N 21/255; G01N 21/251; B05B 11/3042; G05D 11/02; G01N 2201/121

(57) ABSTRACT

A made-to-order system for cosmetics (10) includes: color detection apparatus (12) for detecting a color of a detection object; input apparatus for inputting a color of a cosmetic to be prepared; blend ratio setting apparatus (14) for generating a blend ratio for preparing a cosmetic having the color that is input to the input apparatus, from a plurality of kinds of cosmetic compositions; and a cosmetic preparation apparatus (20) that prepares the cosmetic by discharging and mixing the plurality of kinds of cosmetic compositions by means of respective positive displacement pumps such that the blend ratio generated by the blend ratio setting apparatus (14) is achieved.

### TECHNICAL FIELD

The present invention relates to a made-to-order system for cosmetics and a preparation system therefor including an apparatus that mixes a plurality of kinds of cosmetic compositions to thereby prepare a cosmetic. More specifically, the present invention relates to a made-to-order system for cosmetics and a preparation system therefor capable of efficiently supplying a cosmetic that conforms to the color desired by a customer or the like.

### BACKGROUND ART

In one of sales styles for cosmetics, various kinds of product samples are displayed on shop shelves. In this sales style, a customer selects and purchases a product on the basis of the product samples. Moreover, the customer selects and purchases a product on the basis of explanation and advice from a salesperson in addition to the product samples. However, in the sales style in which various kinds of product samples are displayed on shop shelves, there is a limitation on the kinds of product samples, and hence it is difficult to supply a cosmetic that conforms to the color desired by the customer and the skin type of the customer. In addition, it is more difficult to supply a cosmetic that conforms to requests concerning functionality (for example, a keeping force, a moisture retaining property, or a covering force) and a texture (for example, a pearly texture or a matte texture).

Here, the term “keeping force” means, for example, the keeping force of a cosmetic against water, tears, sweats, sebum, or rubbing by a finger. Moreover, the term “covering force” means, for example, the capability of covering up color unevenness and pores.

In the case where the cosmetic is a foundation, the customer tends to select the color of the cosmetic with reference to the color of the skin of the customer. Moreover, in the case where the cosmetic is a concealer, the customer tends to select the color of the cosmetic with reference to the color of the skin of the customer and the color of a use target portion (for example, a blemish, dark circles under eyes, and a scar). In the case where the cosmetic is a lipstick, an eye shadow, or a blusher, the customer tends to select the color of the cosmetic considering the preference of the customer with reference to the color of the skin of the customer. Because the color of the cosmetic thus selected is an important element for the customer to purchase the cosmetic, it is particularly important to supply the cosmetic that conforms to the color desired by the customer.

In order to supply the cosmetic that conforms to the color desired by the customer, the skin type of the customer, and the like, a made-to-order sales style is available. In this sales style, the salesperson organizes requests concerning functionality and a texture as well as the color desired by the customer and the skin type of the customer, through visual recognition and listening, and prepares the cosmetic on the basis of the organized information.

Various proposals for such a made-to-order sales style have been made up to now, and Patent Literatures 1 and 2 are examples thereof. Patent Literature 1 proposes a made-to-order system for cosmetics. In the made-to-order system, a small-scale cosmetic factory is located next to a shop in which a salesperson listens to requests concerning a cosmetic from a customer. The small-scale cosmetic factory includes: means for mixing materials on the basis of the prescription best for the requests from the customer and preparing a cosmetic bulk in a small amount; and means for putting the cosmetic bulk into a container or the like.

In an embodiment thereof, an adviser as a salesperson and a colorist listen to the requests from the customer through counseling, and decide the item, the color, and the texture of the cosmetic, and the colorist inputs the prescription into the made-to-order system. Moreover, in the small-scale cosmetic factory, a technical person responsible for production prepares cosmetic compositions by means of the preparation means, in accordance with the color specimen and the prescription brought in by the colorist.

Moreover, Patent Literature 2 proposes a cosmetic preparation apparatus that prepares a color cosmetic to order, in order to deliver the color cosmetic to a customer in a short time. The cosmetic preparation apparatus includes: means for receiving an operation command concerning the prescription best for the customer; a plurality of dispensers that respectively house cosmetic compositions; means for scaling and dispensing predetermined cosmetic compositions at respective predetermined concentrations into a preparation chamber, in response to the operation command; and means for delivering a prepared product scaled and dispensed into a container, as the color cosmetic to the customer. In Patent Literature 2, a ProMlnent Gamma/4 pump (so-called diaphragm pump) obtainable from Dosiertechnik GmbH is described to be particularly suitable for a pump used for each dispenser.

### CITATION LIST

### Patent Literature

Patent Literature 1: Japanese Patent Application Publication No. 2001-126140
Patent Literature 2: National Publication of International Patent Application No. 09-502172

### SUMMARY OF INVENTION

### Technical Problem

In the made-to-order sales style for cosmetics, the salesperson organizes requests concerning functionality and a texture as well as the color desired by the customer and the skin type of the customer, through visual recognition and listening, and prepares the cosmetic on the basis of the organized information. Moreover, because the color of the cosmetic is an important element for the customer to purchase the cosmetic, it is particularly important to supply the cosmetic that conforms to the color desired by the customer.

However, the work of organizing the color desired by the customer through visual recognition and listening by the salesperson must inevitably be based on the experience of the salesperson and thus depends on the individual skill of the salesperson. Hence, the work may require time, and the color of the prepared cosmetic and the color desired by the customer may be different from each other.

In the made-to-order system proposed in Patent Literature 1, the adviser as a salesperson and the colorist listen to the requests from the customer through counseling, and decide the item, the color, and the texture of the cosmetic, and the colorist inputs the prescription into the made-to-order system. Hence, the work of organizing the color desired by the customer must inevitably be based on the experience of the salesperson and thus depends on the individual skill of the salesperson, the organization work may require time, and the color of the prepared cosmetic and the color desired by the customer may be different from each other. Moreover, because the technical person responsible for production prepares cosmetic compositions in accordance with the color specimen, this work must inevitably be based on the experience of the technical person and thus depends on the individual skill of the technical person, the preparation work may require time, and the color of the prepared cosmetic and the color desired by the customer may be different from each other.

Moreover, in the cosmetic preparation apparatus proposed in Patent Literature 2, the cosmetic can be prepared at a predetermined concentration using the plurality of dispensers. Hence, the technical person responsible for production does not need to prepare cosmetic compositions in accordance with the color specimen, the time required for the preparation work can be reduced, and the problem that the color of the prepared cosmetic and the color desired by the customer are different from each other due to the preparation work can be prevented. However, the work of organizing the color desired by the customer must still inevitably be based on the experience of the salesperson and thus depends on the individual skill of the salesperson, the organization work may require time, and the color of the prepared cosmetic and the color desired by the customer may be different from each other due to the organization work.

The present invention, which has been made in view of the above-mentioned circumstances, has an object to provide a made-to-order system for cosmetics and a preparation system therefor capable of efficiently supplying a cosmetic that conforms to the color desired by a customer or the like.

### Solution to Problem

The gist of the present invention is as follows.

(1) A made-to-order system for cosmetics includes: color detection apparatus for detecting a color of a detection object; input apparatus for inputting a color of a cosmetic to be prepared; blend ratio setting apparatus for generating a blend ratio for preparing a cosmetic having the color that is input to the input apparatus, from a plurality of kinds of cosmetic compositions; and cosmetic preparation apparatus that prepares the cosmetic by discharging the plurality of kinds of cosmetic compositions by means of respective positive displacement pumps such that the blend ratio generated by the blend ratio setting apparatus is achieved, and mixing the discharged cosmetic compositions.
(2) The made-to-order system for cosmetics according to (1) given above further includes a display device for displaying the color detected by the color detection apparatus.
(3) In the made-to-order system for cosmetics according to (1) or (2) given above, the color detection apparatus includes: an imaging device for imaging a skin of a customer that is the detection object; and an image analysis device that analyzes image data imaged by the imaging device to thereby detect a color of the skin of the customer.
(4) In the made-to-order system for cosmetics according to (1) or (2) given above, the detection object is image data on a photograph obtained by imaging a color specimen together with a skin of a customer, and the color detection apparatus includes: a color correction device for correcting a color of the image data on the basis of a color of the color specimen in the image data; and an image analysis device that analyzes the image data processed by the color correction device to thereby detect a color of the skin of the customer.
(5) In the made-to-order system for cosmetics according to (1) or (2) given above, the detection object is a photograph obtained by imaging a color specimen together with a skin of a customer, and the color detection apparatus includes: a scanner that captures the photograph as image data; a color correction device for correcting a color of the image data on the basis of a color of the color specimen in the image data; and an image analysis device that analyzes the image data processed by the color correction device to thereby detect a color of the skin of the customer.
(6) The made-to-order system for cosmetics according to any one of (1) to (5) given above further includes balance analysis apparatus for obtaining, from an amount of a balance of each of a plurality of kinds of cosmetic compositions supplied to the customer, a color of a cosmetic sample that is prepared such that the balance of each cosmetic composition becomes this amount.
(7) In the made-to-order system for cosmetics according to (1) or (2) given above, the detection object is a cosmetic sample, and the color detection apparatus includes a colorimeter that detects a color from the cosmetic sample.
(8) The made-to-order system for cosmetics according to any one of (1) to (7) given above further includes a recommended color analysis device for obtaining a recommended color on the basis of the color detected by the color detection apparatus. In this made-to-order system for cosmetics, the display device further displays the recommended color obtained by the recommended color analysis device.
(9) In the made-to-order system for cosmetics according to (8) given above, the recommended color analysis device obtains the recommended color considering customer information, fashionable colors, or a season on the basis of the color detected by the color detection apparatus.
(10) The made-to-order system for cosmetics according to (8) or (9) given above further includes input assist apparatus for inputting the color detected by the color detection apparatus or the color obtained by the recommended color analysis device, to the input apparatus.
(11) In the made-to-order system for cosmetics according to any one of (1) to (10) given above, the blend ratio setting apparatus includes: an amount-of-change database in which records are stored in the state where an additive amount of each cosmetic composition is associated with an amount of change of each component of a color system value for the additive amount; and an application that generates the blend ratio by selecting the additive amount of each cosmetic composition and the amount of change of each component of the color system value from the amount-of-change database, and deciding the additive amount of each cosmetic composition, on the basis of a difference between a color system value of the color that is input to the input apparatus and a color system value of a reference color.
(12) In the made-to-order system for cosmetics according to (11) given above, the additive amount of the cosmetic composition in each record of the amount-of-change database changes depending on a separation capability of the positive displacement pumps.
(13) In the made-to-order system for cosmetics according to any of (1) to (12) given above, the positive displacement pumps are uniaxial eccentric screw pumps.
(14) A preparation system for cosmetics includes: color detection apparatus for detecting a color of a detection object; input apparatus for inputting a color of a cosmetic to be prepared; blend ratio setting apparatus for generating a blend ratio for preparing a cosmetic having the color that is input to the input apparatus, from a plurality of kinds of cosmetic compositions; and cosmetic preparation apparatus that prepares the cosmetic by discharging the plurality of kinds of cosmetic compositions by means of respective positive displacement pumps such that the blend ratio generated by the blend ratio setting apparatus is achieved, and mixing the discharged cosmetic compositions.
(15) In the preparation system for cosmetics according to (14) given above, the detection object is image data on a photograph obtained by imaging a subject, the subject is a human skin or a color sample, and the color detection apparatus includes an image analysis device that analyzes the image data to thereby detect a color of the subject.
(16) In the preparation system for cosmetics according to (14) given above, the detection object is image data on a photograph obtained by imaging a color specimen together with a subject, the subject is a human skin or a color sample, and the color detection apparatus includes: a color correction device for correcting a color of the image data on the basis of a color of the color specimen in the image data; and an image analysis device that analyzes the image data processed by the color correction device to thereby detect a color of the detection object.
(17) The preparation system for cosmetics according to any one of (14) to (16) given above further includes balance analysis apparatus for obtaining, from an amount of a balance of each of a plurality of kinds of cosmetic compositions used to make a cosmetic sample, a color of the cosmetic sample that is prepared such that the balance of each cosmetic composition becomes this amount.
(18) In the preparation system for cosmetics according to (14) given above, the detection object is a cosmetic sample or a color sample, and the color detection apparatus includes a colorimeter that detects a color from the detection object.
(19) In the preparation system for cosmetics according to any one of (14) to (18) given above, the blend ratio setting apparatus includes: an amount-of-change database in which records are stored in the state where an additive amount of each cosmetic composition is associated with an amount of change of each component of a color system value for the additive amount; and an application that generates a blend ratio by selecting the additive amount of each cosmetic composition and the amount of change of each component of the color system value from the amount-of-change database, and deciding the additive amount of each cosmetic composition, on the basis of a difference between a color system value of the color that is input to the input apparatus and a color system value of a reference color, and deciding the additive amount of each cosmetic composition.
(20) In the preparation system for cosmetics according to (19) given above, the additive amount of the cosmetic composition in each record of the amount-of-change database changes depending on a separation capability of the positive displacement pumps.
(21) In the preparation system for cosmetics according to any one of (14) to (20) given above, the positive displacement pumps are uniaxial eccentric screw pumps.

### Advantageous Effects of Invention

Because the made-to-order system for cosmetics of the present invention includes the color detection apparatus for detecting the color of the detection object, the made-to-order system can precisely and efficiently decide the color desired by the customer. Hence, the time required for work of organizing the color desired by the customer can be reduced, and inconsistency between the color of the prepared cosmetic and the color desired by the customer can be suppressed. Moreover, the cosmetic preparation apparatus discharges the cosmetic compositions by means of the respective positive displacement pumps, and mixes the discharged cosmetic compositions. Hence, the time required for preparation work can be reduced, and the color of the prepared cosmetic and the color desired by the customer can be prevented from being different from each other due to the preparation work. Further, a cosmetic can be sold in an arbitrary amount.

Because the preparation system for cosmetics of the present invention includes the color detection apparatus for detecting the color of the detection object, the preparation system can precisely and efficiently decide the color desired by the worker or the like. Hence, the time required for work of organizing the desired color can be reduced, and inconsistency between the color of the prepared cosmetic and the desired color can be suppressed. Moreover, the cosmetic preparation apparatus discharges the cosmetic compositions by means of the respective positive displacement pumps, and mixes the discharged cosmetic compositions. Hence, the time required for preparation work can be reduced, and the color of the prepared cosmetic and the desired color can be prevented from being different from each other due to the preparation work. Further, a cosmetic can be prepared in an arbitrary amount.

### BRIEF DESCRIPTION OF DRAWINGS

FIG. 1 is a block diagram illustrating a configuration example of a made-to-order system for cosmetics according to the present invention.

FIG. 2 is a schematic diagram illustrating a color map for describing a color classification database.

FIG. 3 is a perspective view schematically illustrating an external appearance of a configuration example of a cosmetic preparation apparatus.

FIG. 4 is a front view schematically illustrating an inside of the configuration example of the cosmetic preparation apparatus.

FIG. 5 is a side view schematically illustrating the inside of the configuration example of the cosmetic preparation apparatus.

FIG. 6 is a top view schematically illustrating flow paths of cosmetic compositions in the configuration example of the cosmetic preparation apparatus.

FIG. 7 is a cross-sectional view schematically illustrating a configuration example of a uniaxial eccentric screw pump preferably used as each pump of the cosmetic preparation apparatus.

FIG. 8 is a diagram illustrating a processing flow example of the made-to-order system for cosmetics according to the present invention in which FIG. 8(a) illustrates a main process, FIG. 8(b) illustrates a process of deciding a color, FIG. 8(c) illustrates a process of deciding a moisture retaining property and the like, and FIG. 8(d) illustrates a process of generating a blend ratio.

FIG. 9 is a perspective view illustrating an example of a plurality of kinds of cosmetic compositions supplied to a customer.

FIG. 10 is a schematic diagram illustrating a configuration example of an amount-of-change database.

FIG. 11 is a graph illustrating color differences ΔE between cases.

FIG. 12 is a diagram illustrating a processing flow example in the case where a sample making kit is used for color decision.

### DESCRIPTION OF EMBODIMENTS

### Made-to-Order System for Cosmetics of Present Invention

Hereinafter, a made-to-order system for cosmetics of the present invention is described with reference to the drawings.

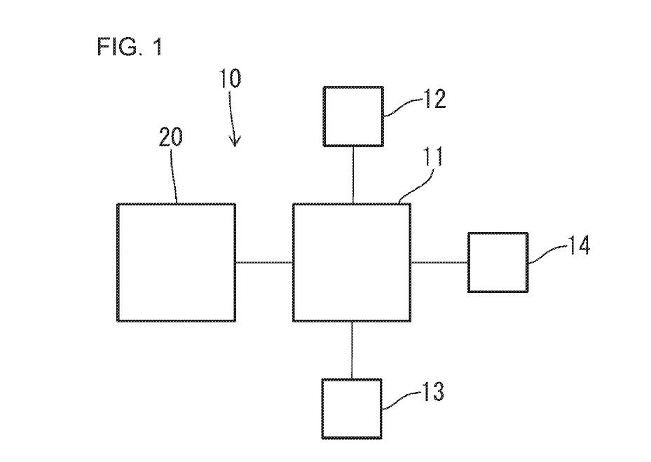

FIG. 1 is a block diagram illustrating a configuration example of the made-to-order system for cosmetics according to the present invention. A made-to-order system 10 illustrated in FIG. 1 includes: color detection apparatus 12 for detecting the color of a detection object; skin type determination apparatus 13 for determining the skin type of a customer; blend ratio setting apparatus 14 for generating the blend ratio of cosmetic compositions; and cosmetic preparation apparatus 20 that prepares a cosmetic.

The made-to-order system 10 further includes a personal computer 11, and the color detection apparatus 12, the skin type determination apparatus 13, the blend ratio setting apparatus 14, and the cosmetic preparation apparatus 20 are connected to the personal computer 11. The color of the detection object that is detected by the color detection apparatus 12 is transmitted to the personal computer 11, and an application receives the transmitted color and displays the same on a display. Similarly, the skin type determined by the skin type determination apparatus 13 is transmitted to the personal computer 11, and an application receives the transmitted skin type and displays the same on the display. Moreover, the personal computer 11 fulfills a role as an input/output apparatus for the blend ratio setting apparatus 14. Further, the personal computer 11 fulfills a role as an input apparatus for the cosmetic preparation apparatus 20.

The cosmetic preparation apparatus 20 stores therein a plurality of kinds of cosmetic compositions, and positive displacement pumps for respectively discharging the cosmetic compositions by arbitrary amounts are provided to the cosmetic preparation apparatus 20 for each cosmetic composition. Moreover, the cosmetic preparation apparatus 20 has a function of mixing a plurality of discharged cosmetic compositions. Hence, if the cosmetic preparation apparatus 20 operates the positive displacement pumps to thereby discharge and mix a plurality of cosmetic compositions by respective arbitrary amounts, the cosmetic preparation apparatus 20 can prepare a cosmetic having a desired blend ratio as needed.

The color detection apparatus 12 performs color detection on the detection object. Here, the detection object changes depending on a sales style for cosmetics, and examples thereof include a skin of the customer, a photograph obtained by imaging the skin of the customer, image data on the photograph obtained by imaging the skin of the customer, and a cosmetic sample. The photograph obtained by imaging the skin of the customer can be a photograph obtained by imaging a color specimen together with the skin of the customer. Similarly, the image data on the photograph obtained by imaging the skin of the customer can be image data on the photograph obtained by imaging the color specimen together with the skin of the customer. Meanwhile, it is also possible to detect the color of the cosmetic sample from the balance of each of a plurality of kinds of cosmetic compositions supplied to the customer, using balance analysis apparatus.

In the case where the detection object is the skin of the customer, the color detection apparatus 12 can be configured by an imaging device for imaging the skin of the customer (detection object) and an image analysis device that analyzes image data imaged by the imaging device to thereby detect the color of the skin of the customer. An optical device capable of imaging the detection object such as the skin of the customer can be adopted as the imaging device, and, for example, a CCD camera or a CMOS can be adopted thereas. A cover that blocks external light may be attached to the camera in order to enable blocking influences of the external light when the skin of the customer or the like is imaged and enable the imaging under given conditions.

Moreover, in the case where the detection object is the photograph obtained by imaging the skin of the customer, the color detection apparatus 12 can be configured by a scanner that captures the photograph as image data and an image analysis device that detects the color of the skin of the customer from the image data captured by the scanner. In the case where the detection object is the image data on the photograph obtained by imaging the skin of the customer, the color detection apparatus 12 can be configured by only an image analysis device that detects the color of the skin of the customer from the image data.

In the case of using the balance of each of the plurality of kinds of cosmetic compositions supplied to the customer and the case where the detection object is the cosmetic sample, a sample making kit made of the plurality of kinds of cosmetic compositions is supplied in advance to the customer.

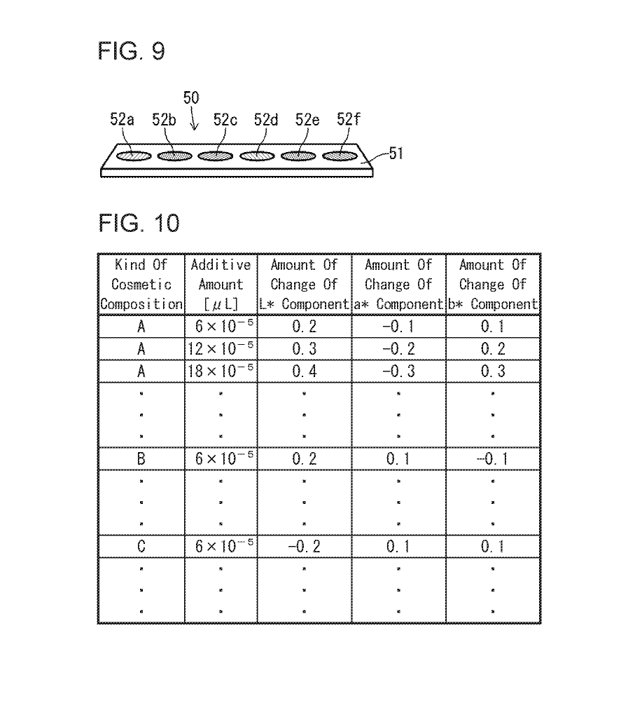

FIG. 9 is a perspective view illustrating an example of the plurality of kinds of cosmetic compositions supplied to the customer. A sample making kit 50 illustrated in FIG. 9 includes a pallet 51 and a plurality of kinds of cosmetic compositions (52a to 52f). The pallet 51 is provided with a plurality of concave parts, the cosmetic compositions (52a to 52f) of different colors are respectively stored in the concave parts, and the cosmetic compositions (52a to 52f) are stored by respective predetermined amounts.

The customer to whom the pallet 51 as described above is supplied mixes the plurality of kinds of stored cosmetic compositions to make a cosmetic sample of a desired color. Then, the color of the sample is detected using each cosmetic composition remaining on the pallet 51 (the balance of each cosmetic composition), or the made sample of the desired color is used as the detection object. Although the made sample of the desired color can be housed in a container, it is preferable to attach the made sample to a film from the perspective of facilitation of handling thereof.

In the case of using the balance of each of the plurality of kinds of cosmetic compositions, if the amount (for example, the volume or the mass) of the balance of each cosmetic composition is measured, the amount of each cosmetic composition used for the sample of the desired color, that is, the color of the made sample can be identified. Hence, it is preferable that the made-to-order system for cosmetics of the present invention include balance analysis apparatus for obtaining, from the amount of the balance of each cosmetic composition, the color of a sample that is prepared such that the balance of each cosmetic composition becomes this amount. In this case, the made-to-order system for cosmetics of the present invention may further include measurement device for measuring the amount of the balance of each cosmetic composition.

Meanwhile, in the case where the detection object is the made sample of the desired color, the color detection apparatus can be configured by a colorimeter that detects the color from the sample.

It is preferable that the made-to-order system of the present invention include a display device for displaying the color detected by the color detection apparatus. For example, the display of the personal computer 11 illustrated in FIG. 1 can be used as the display device.

Instead of the display device or together with the display device, the made-to-order system of the present invention may include information transmission apparatus for transmitting the detected color to a terminal of the customer. Specifically, the made-to-order system of the present invention may transmit information to the terminal (for example, a personal computer or a mobile phone) of the customer via the information transmission apparatus (for example, a Web server or an e-mail server), and may display the detected color on a display of the terminal.

In the made-to-order system of the present invention, the color of the cosmetic to be prepared is decided on the basis of the color of the detection object that is detected by the color detection apparatus 12, and the decided color is input using input apparatus. In the made-to-order system 10 illustrated in FIG. 1, the personal computer 11 fulfills a role as the input apparatus.

In deciding the color of the cosmetic, a mode in which the color of the detection object that is detected by the color detection apparatus is defined as the color of the cosmetic to be prepared without any change may be adopted. Alternatively, a mode in which the detected color of the detection object is changed considering advice from a salesperson and the preference of the customer may be adopted. Which of the modes should be adopted can be set as appropriate depending on the kind of the cosmetic and a sales style.

In the case of adopting the mode in which the color of the detection object that is detected by the color detection apparatus is defined as the color of the cosmetic to be prepared without any change, it is preferable that the made-to-order system include input assist apparatus for inputting the color to the input apparatus on the basis of the color detected by the color detection apparatus. Consequently, incorrect inputs can be prevented, and the cosmetic can be efficiently produced.

In the case of adopting the mode in which the detected color of the detection object is changed, it is preferable that the made-to-order system include a recommended color analysis device for obtaining a recommended color on the basis of the color detected by the color detection apparatus and that the display device display the recommended color obtained by the recommended color analysis device together with the detected color. The recommended color analysis device obtains the recommended color, for example, considering customer information, fashionable colors, or the season on the basis of the color detected by the color detection apparatus.

Actual sales results, preferences, and requests (such as a request to cover up a reddish face) from the customer correspond to the customer information. The recommended color is obtained considering such customer information, fashionable colors, or the season, and is displayed on the display device, whereby the color can be efficiently decided. Here, for example, in the case where the cosmetic is a foundation and where the season is summer, changing the detected color such that a B component increases in an RGB color model corresponds to considering the season. Moreover, in the case where the cosmetic is a foundation and where the season is winter, changing the detected color such that an R component increases in the RGB color model corresponds to considering the season.

In the case where the recommend color is obtained by the recommended color analysis device as described above, it is preferable that the made-to-order system include, as the input assist apparatus, input assist apparatus for inputting the color detected by the color detection apparatus or the color obtained by the recommended color analysis device, to the input apparatus. Consequently, in response to that an operator (the salesperson or the customer) selects a color using the input device (a mouse or a touch panel), the color is input to the input apparatus via the input assist apparatus.

Instead of the display device or together with the display device, the recommended color analysis device may display the recommended color to the display of the terminal of the customer together with the detected color via the information transmission apparatus.

In order to prepare the cosmetic having the color thus decided using the cosmetic preparation apparatus 20, the blend ratio setting apparatus 14 generates a blend ratio for preparing the cosmetic having the input color from the plurality of kinds of cosmetic compositions. More specifically, the blend ratio setting apparatus 14 adjusts, for example, the content of each pigment in accordance with the input color, and generates such a blend ratio that makes the color of the cosmetic to be prepared coincident with the input color.

The blend ratio setting apparatus 14 can be configured by, for example: a color classification database in which each color classification is stored in association with a color range in which the color classification is usable; an application that selects a color classification in which the input color is within a usable range, from the color classification database; a blend ratio database in which each color classification is stored in association with a blend ratio for preparing a cosmetic in the color classification; and an application that selects a blend ratio on the basis of an input color classification.

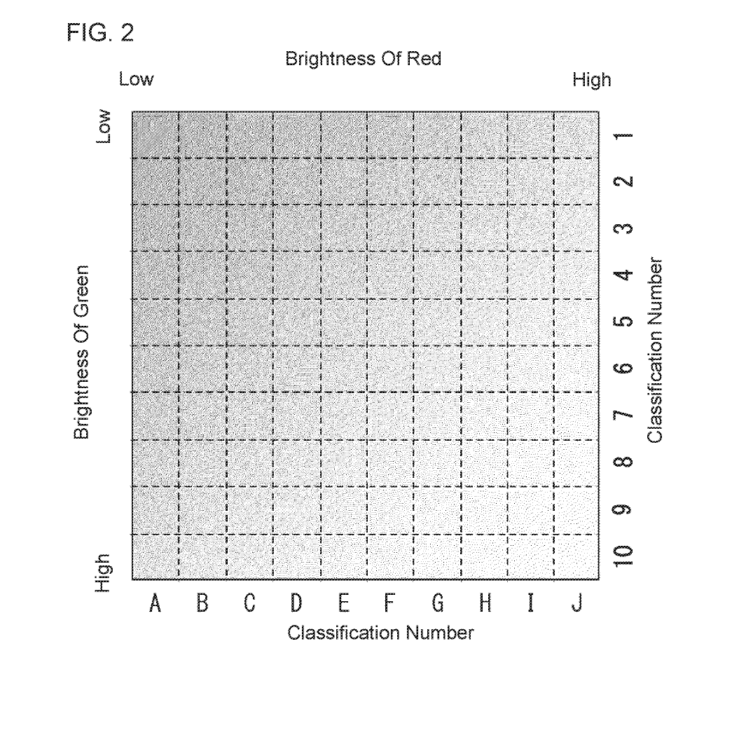

FIG. 2 is a schematic diagram illustrating a color map for describing the color classification database. In the color map illustrated in FIG. 2, the color is expressed by an RGB color model, the brightness of red changes along the horizontal axis, the brightness of green changes along the vertical axis, and the brightness of blue is constant. Chain lines in FIG. 2 represent the boundaries of ranges (regions) in each of which a color classification is usable, and classification numbers (A-1 to J-10) are respectively given to the regions surrounded by the chain lines. Each color classification as described above is usable in the case where the brightnesses of red and green are within its corresponding region and the brightness of blue is within a predetermined range. In this case, in the color classification database, a range in which a given color is usable (the upper limit value and the lower limit value of the brightness of red, the upper limit value and the lower limit value of the brightness of green, and the upper limit value and the lower limit value of the brightness of blue) is stored in association with the classification number of the given color.

A color classification (the classification number of a color) within a usable range is selected from the color classification database as described above via the application, with reference to the input color (for example, the brightnesses of red, green, and blue).

At this time, in the case where the input color is a color ranging over a plurality of color classifications, it is preferable that the application automatically determine to which color classification the input color is closer, and select the best color classification.

Moreover, the above-mentioned blend ratio database may store, for example, each color classification in association with the rotational speed (min⁻¹) of a motor (drive device) that drives a positive displacement pump that discharges each cosmetic composition. More specifically, there is a case where cosmetic compositions are a red pigment, a green pigment, a blue pigment, and a half-finished product of a cosmetic respectively, and where the cosmetic preparation apparatus discharges the cosmetic compositions by means of the rotary positive displacement pumps respectively driven by the motors. In this case, the blend ratio database may store each color classification in association with: the rotational speed (min⁻¹) of the motor that drives the pump that discharges the red pigment; the rotational speed (min⁻ⁱ) of the motor that drives the pump that discharges the green pigment; the rotational speed (min⁻ⁱ) of the motor that drives the pump that discharges the blue pigment; and the rotational speed (min⁻¹) of the motor that drives the pump that discharges the half-finished product of the cosmetic. In this case, the term “half-finished product of the cosmetic” means the cosmetic (product) from which the pigments for adjusting the color are excluded.

Meanwhile, for example, in the case where a pump not using a motor as its drive device (for example, a piston pump using a solenoid and a piezoelectric pump using a piezoelectric element) is adopted as each pump, the blend ratio database may store each color classification in association with parameters (for example, the stroke speed of a piston, an applied voltage, and a cycle) for defining the amount of discharge per unit time of the pump that discharges each cosmetic composition.

If the blend ratio is defined by the parameters for defining the amount of discharge per unit time of the pump such as the rotational speed of the motor in this way, an arbitrary amount of order can be easily dealt with by changing the operation time of the drive device such as the motor.

In the above-mentioned example, the cosmetic compositions are the red pigment, the green pigment, the blue pigment, and the half-finished product of the cosmetic respectively, but a pigment of a different color may be used. Moreover, instead of using the pigments alone, a cosmetic composition obtained by adding another half-finished product of the cosmetic to a pigment or a cosmetic composition obtained by dissolving a pigment in a base material may be used. Moreover, in addition to the pigments, a pearling agent for giving a shiny appearance to the skin, a moisturizer for giving a moist feeling to the skin, and the like may be used as cosmetic compositions, and the color may be adjusted by adding these agents as appropriate.

In the color map illustrated in FIG. 2, the brightness of red changes along the horizontal axis, and the brightness of green changes along the vertical axis. Alternatively, for example, a color map that is created such that the horizontal axis is the content of a pigment A and that the vertical axis is the content of a pigment B may be used. Here, both the pigment A and the pigment B are mixture pigments containing the red pigment, the green pigment, and the blue pigment, but the contents of these pigments are different therebetween.

In this case, the blend ratio setting apparatus 14 can be configured by, for example: a map database in which the contents of the pigments A and B are stored in association with the color (for example, the brightnesses of red, green, and blue) of a cosmetic prepared at the contents thereof; an application that selects a record in which the color of the cosmetic in the map database is the same as the input color (for example, the brightnesses of red, green, and blue), and invokes the contents of the pigments A and B in the selected record; a color classification database in which each color classification is stored in association with a range in which the color classification is usable (for example, the upper limit value and the lower limit value of the pigment A and the upper limit value and the lower limit value of the pigment B); an application that selects a color classification in which the input contents of the pigments A and B are within a usable range, from the color classification database; a blend ratio database in which each color classification is stored in association with a blend ratio for preparing a cosmetic in the color classification; and an application that selects a blend ratio on the basis of an input color classification.

In the above-mentioned example, the color map based on the contents of the pigment A and the pigment B as mixture pigments is used. Alternatively, a color map based on the contents of a cosmetic composition A and a cosmetic composition B each obtained by adding another half-finished product of the cosmetic to a mixture pigment may be used. Alternatively, a color map based on the contents of a cosmetic composition A and a cosmetic composition B each obtained by dissolving a mixture pigment in a base material may be used. Alternatively, a three-dimensional color map based on the contents of three kinds of mixture pigments or the contents of three kinds of cosmetic compositions obtained by adding another half-finished product of the cosmetic to three kinds of mixture pigments may be used.

Moreover, in the color map illustrated in FIG. 2, the color map in which the color is expressed by the RGB color model is used, but a color map in which the color is expressed by another color model, for example, an L*a*b* color model may be used. In this case, L* (brightness) may be adjusted by adjusting the blend ratio of a white pigment (or a pigment of a color close to white), and may be adjusted by adjusting the blend ratios of a pearling agent, a lame agent, and the like.

The blend ratio setting apparatus 14 using the color classifications is described above, but the blend ratio setting apparatus 14 having another configuration can also be adopted for the made-to-order system of the present invention. For example, the relation between the contents of pigments and the color of a cosmetic prepared at the contents thereof is transformed into a function. A mode in which the blend ratio setting apparatus 14 calculates the contents of the pigments from the input color, using the obtained function, to thereby decide a blend ratio can also be adopted. Alternatively, a mode in which the blend ratio setting apparatus includes an amount-of-change database can also be adopted.

The mode in which the blend ratio setting apparatus includes the amount-of-change database uses the relation between the additive amount of a cosmetic composition and the amount of change of each component of a color system value. Specifically, this mode uses the fact that the amount of change of each component of the color system value in the case where a cosmetic composition Y (for example, the blue pigment) is quantitatively added to a composition X of a given color (for example, red) is the same as the amount of change of each component of the color system value in the case where the cosmetic composition Y is quantitatively added to a composition Z of a different color (for example, yellow). The relation between the additive amount of the cosmetic composition and the amount of change of each component of the color system value has been identified as a result of a basic test to be described later.

Here, in the case of using the L*a*b* color model, the amount of change (ΔL*, Δa*, Δb*) of each component of the color system value can be calculated according to Formulae (1) to (3) given below.

ΔL*=a1−b1 (1)

Δa*=a2−b2 (2)

Δb*=a3−b3 (3)

where the color system value of the color before addition is denoted by (a1, a2, a3) and the color system value of the color after addition is denoted by (b1, b2, b3).

FIG. 10 is a schematic diagram illustrating a configuration example of the amount-of-change database. The amount-of-change database illustrated in FIG. 10 is provided with, as its fields, the kind of a cosmetic composition, the additive amount (μL) of the cosmetic composition, and the amount of change of each component of the color system value for the additive amount (in FIG. 10, the amount of change of each component value in the L*a*b* color model). In this way, records are stored in the state where the additive amount of each cosmetic composition is associated with the amount of change of each component of the color system value for the additive amount.

In constructing the amount-of-change database as described above, for example, a test is conducted. In the test, a process of adding the cosmetic composition Y to the composition X by a predetermined amount and a process of measuring the color of the composition X after the addition using a colorimeter are repeated. Once the amount of change of each component of the color system value is calculated and input from results of the test, the amount-of-change database can be constructed. In the case of adding a plurality of cosmetic compositions, the relation between the additive amount of each cosmetic composition and the amount of change of each component of the color system value is obtained for all the cosmetic compositions.

In the mode in which the blend ratio setting apparatus includes the amount-of-change database as described above, the blend ratio setting apparatus includes an application that generates a blend ratio. On the basis of the difference between the color system value of the color that is input to the input apparatus and the color system value of a reference color, the application selects the additive amount of the cosmetic composition and the amount of change of each component of the color system value from the amount-of-change database, and decides the additive amount of the cosmetic composition. In this way, the application generates a blend ratio. Here, the reference color is a color that serves as a criterion for generating a blend ratio. A blend ratio for preparing a cosmetic having the reference color is obtained in advance.

In generating a blend ratio using the application as described above, first, the application calculates the difference between the color system value of the input color and the color system value of the reference color, for each component. On the basis of the difference between the color system value of the input color and the color system value of the reference color, the application refers to the amount-of-change database to decide the kind of a cosmetic composition to be added and the additive amount thereof. On this occasion, the application separates the difference between the color system value of the input color and the color system value of the reference color into a plurality of units as needed, and decides the kind of a cosmetic composition and the additive amount thereof for each separated difference between the color system values.

The application reflects the kind of a cosmetic composition to be added and the additive amount thereof thus decided, in the blend ratio for preparing the cosmetic having the reference color (for example, the content (μL) of each cosmetic composition), to thereby generate a blend ratio.

In the mode in which the blend ratio setting apparatus includes the amount-of-change database as described above, the relation between the additive amount and the amount of change of the color system value for each cosmetic composition can be obtained to thereby construct the amount-of-change database. Hence, the amount-of-change database can be efficiently constructed while the color reproducibility can be secured.

In the made-to-order system for cosmetics of the present invention, it is preferable that the additive amount of the cosmetic composition in each record of the amount-of-change database change depending on the separation capability of the positive displacement pumps. As described above, the amount-of-change database can be constructed by, for example, conducting a test. In the test, a process of adding the cosmetic composition Y to the composition X by a predetermined amount and a process of measuring the color of the composition X after the addition using a colorimeter are repeated. In the process of adding the cosmetic composition Y to the composition X by a predetermined amount, the predetermined amount is set to the separation capability of the positive displacement pump. Consequently, the color reproducibility can be enhanced.

Here, the term “separation capability of the positive displacement pump” means the minimum amount of discharge (μL) of the positive displacement pump. For example, in the case of a positive displacement pump driven by a pulse motor, the amount of discharge per pulse corresponds to the separation capability.

Then, the cosmetic preparation apparatus 20 of the made-to-order system of the present invention as illustrated in FIG. 1 discharges a plurality of kinds of cosmetic compositions by means of the respective pumps on the basis of the blend ratio generated by the blend ratio setting apparatus, and mixes the discharged cosmetic compositions. As a result, the cosmetic preparation apparatus 20 prepares a cosmetic of the decided color.

Because the made-to-order system of the present invention as described above includes the color detection apparatus 12 for detecting the color of the detection object, the made-to-order system can precisely and efficiently decide the color desired by the customer. Hence, the time required for work of organizing the color desired by the customer can be reduced, and inconsistency between the color of the prepared cosmetic and the color desired by the customer can be suppressed.

In the made-to-order system of the present invention, the cosmetic preparation apparatus 20 discharges the cosmetic compositions by means of the respective positive displacement pumps, and mixes the discharged cosmetic compositions. Hence, a technical person responsible for production does not need to prepare the cosmetic compositions in accordance with a color specimen. Hence, the time required for the preparation work can be reduced, and the color of the prepared cosmetic and the color desired by the customer can be prevented from being different from each other due to the preparation work. The cosmetic preparation apparatus can prepare a cosmetic in an arbitrary amount, and hence the made-to-order system of the present invention can sell a cosmetic in an arbitrary amount. Moreover, a sample can be provided in a small amount to the customer.

Here, a method of classifying the skin type into a normal skin, a dry skin, an oily skin, and an oily dry skin is widely used. In the case of foundations, it is important to change a moisture retaining property, that is, change the blend ratio of a cosmetic composition having a moisture retaining property in accordance with the skin type. Hence, in the case where the cosmetic is a foundation, it is preferable that the made-to-order system of the present invention include the skin type determination apparatus 13 for determining the skin type of the customer and that the blend ratio setting apparatus 14 generate a blend ratio for preparing a cosmetic having the input color and the input moisture retaining property from a plurality of kinds of cosmetic compositions.

If the made-to-order system of the present invention includes the skin type determination apparatus 13, the skin type of the customer can be precisely and efficiently recognized. This skin type determination (classification) can be made on the basis of the moisture content of the skin of the customer. The moisture content of the skin of the customer can be measured according to a capacitance measurement method of indirectly calculating the moisture content of a horny layer from a measured capacitance or a conductance measurement method of indirectly calculating the moisture content of a horny layer from an electrical conductance. Hence, the skin type determination apparatus can be configured by, for example, a skin surface horny layer moisture content measurement apparatus.

The skin type is determined using the moisture content of the skin of the customer thus measured, and the salesperson or the customer decides a moisture retaining property of the cosmetic on the basis of the determined skin type. The decided moisture retaining property is input to the blend ratio setting apparatus 14 together with the color, and the blend ratio setting apparatus 14 generates the blend ratio for preparing the cosmetic having the input color and the input moisture retaining property from the plurality of kinds of cosmetic compositions. More specifically, the blend ratio setting apparatus 14 adjusts, for example, the content of a moisturizer such as urea and glycerin in accordance with the input moisture retaining property, and generates such a blend ratio that makes the moisture retaining property of the cosmetic to be prepared coincident with the input moisture retaining property. As a result, the foundation prepared by the cosmetic preparation apparatus has not only a satisfying color but also a satisfying moisture retaining property.

It is preferable that the made-to-order system of the present invention further include moisture retaining property selection apparatus for selecting a moisture retaining property of the cosmetic on the basis of the determined skin type. The moisture retaining property selection apparatus can be achieved by, for example: a skin type database in which a skin type is stored in association with a moisture retaining property suitable for the skin type; and an application for searching the skin type database. This enables the customer to efficiently decide a moisture retaining property.

It is preferable that, in the made-to-order system of the present invention, at least one or more conditions of a texture, a keeping force, and a covering force can further be input to the blend ratio setting apparatus 14, and the blend ratio setting apparatus can generate a blend ratio for preparing a cosmetic satisfying the input condition from a plurality of kinds of cosmetic compositions. Consequently, the cosmetic to be prepared can be brought into a state desired by the customer in terms of not only the color but also the texture (for example, a pearly texture or a matte texture), the keeping force, and/or the covering force.

Here, the pearly texture and the matte texture can be adjusted by changing the content of a pearling agent such as ethylene glycol distearate in accordance with the input texture. Moreover, the keeping force can be adjusted by changing the content of silicone in accordance with the input keeping force, and the covering force can be adjusted by changing the content of a pigment having a high covering force such as titanium oxide and alumina in accordance with the input covering force.

It is preferable that, in the made-to-order system of the present invention, the color detection apparatus further include a color correction device for correcting the color of image data transmitted to an image analysis device. If the skin of the customer is imaged by an imaging device such as a camera, the color thereof changes depending on illumination and the like, and hence the color correction device is provided to eliminate influences thereof. In this mode, a color specimen is prepared in advance, and the color (color system value) of the color specimen is measured in advance. For example, at the time of imaging by the imaging device, a predetermined color specimen may be arranged in the field of view of the imaging device and imaged together with the skin of the customer, and the color detection apparatus may make such a correction that the color of the color specimen in the imaged image data is coincident with an original color (the color system value measured in advance).

Specifically, in the case where the detection object is the image data on the photograph obtained by imaging the color specimen together with the skin of the customer, it is preferable that the color detection apparatus include: a color correction device for correcting the color of the image data on the basis of the color of the color specimen in the image data; and an image analysis device that analyzes the image data processed by the color correction device to thereby detect the color of the skin of the customer. Moreover, in the case where the detection object is the photograph obtained by imaging the color specimen together with the skin of the customer, it is preferable that the color detection apparatus include: a scanner that captures the photograph as image data; a color correction device for correcting the color of the image data on the basis of the color of the color specimen in the image data; and an image analysis device that analyzes the image data processed by the color correction device to thereby detect the color of the skin of the customer.

It is preferable that the made-to-order system of the present invention include color classification display apparatus that displays a color classification in which the color detected by the color detection apparatus is usable, on the display. In this case, the color map as illustrated in FIG. 2 is displayed on the display, and to which color classification the detected color corresponds is indicated on the color map. The customer can select a color classification that suits his/her preference, with reference to the indicated color classification.

For example, when the color of the skin of the customer that is detected by the color detection apparatus corresponds to the classification number “G-5” on the color map, in the case where the customer desires a cosmetic of a more reddish color, the customer may select, for example, the classification number “G-4”. Note that, in the above-mentioned example, the customer selects the classification number “G-4” on the basis of the classification number “G-5” of the detected color of the skin of the customer, but direct designation of a desired color, which is not based on the detected color, may be possible.

Moreover, the chain lines and the classification numbers as illustrated in FIG. 2 may be omitted on the color map displayed on the display. In this case, instead of designating the desired color using the corresponding classification number, the customer may designate the desired color by selecting an arbitrary point on the color map using the input apparatus. For example, the customer designates the desired color by clicking with the mouse or touching the touch panel. The blend ratio setting apparatus 14 selects a blend ratio from the color classification thus selected. Consequently, a color that suits the preference of the customer can be more efficiently decided, and a cosmetic of the color can be more efficiently prepared.

In the case where the cosmetic is a concealer, it is preferable that the made-to-order system of the present invention further include color selection apparatus for selecting the color of the concealer suitable for the detected color of the skin of the customer and the detected color of a use target portion (for example, a blemish, dark circles under eyes, a dullness, a pimple, and a scar) of the concealer. This enables the customer to efficiently decide the color of the concealer. The color selection apparatus can be achieved by, for example: a database in which the color of the skin and the color of the use target portion of the concealer are stored in association with the color of the concealer suitable for these conditions; and an application for searching the database.

The color classification in which the color selected by the color selection apparatus is usable may be displayable on the display by the color classification display apparatus. This enables the customer to select a color classification that suits his/her preference, with reference to the displayed color classification, similarly to the above-mentioned case.

In the case where the cosmetic is a lipstick, an eye shadow, a blusher, or the like, it is preferable that the made-to-order system of the present invention further include color extraction apparatus for extracting the color of the cosmetic suitable for the detected color of the skin of the customer. This enables the customer to efficiently decide the color of the cosmetic. The color extraction apparatus can be achieved by, for example: a database in which the color of the skin is stored in association with the color of the cosmetic suitable for the color of the skin; and an application for searching the database.

The color classification in which the color extracted by the color extraction apparatus is usable may be displayable on the display by the color classification display apparatus. This enables the customer to select a color classification that suits his/her preference, with reference to the displayed color classification, similarly to the above-mentioned case.

It is preferable that the made-to-order system of the present invention further include a cosmetic simulation apparatus that virtually displays the state where the cosmetic is applied using the detected color of the skin of the customer. The cosmetic simulation apparatus displays, on the display, for example, the state where the cosmetic having the color selected by the customer or the salesperson is applied to a face image having the detected color of the skin of the customer. This enables the customer to efficiently decide the color of the cosmetic.

Further, it is preferable that the cosmetic simulation apparatus include a light source simulation apparatus that virtually displays a difference in how the color of the cosmetic looks depending on different light sources. In this case, for example, the customer or the salesperson selects light source information (for example, the kind of light source such as a fluorescent light, an incandescent bulb, and natural light, the luminance of the light source, and the color of the light source) on the display or from the input apparatus. The light source simulation apparatus displays, on the display, an image that is output by the cosmetic simulation apparatus while reflecting a state of the selected light source. This enables the customer to check how the selected color looks in various environments in which the cosmetic is actually used and to more efficiently and precisely decide the color of the cosmetic.

It is preferable that the made-to-order system of the present invention further include a storage device (not illustrated) for storing the blend ratio generated by the blend ratio setting apparatus in association with customer ID information for identifying the customer. Consequently, in the case where the customer orders the same cosmetic, the cosmetic can be efficiently prepared and supplied without the need for detection of the color of the detection object and the like. The blend ratio and the customer ID information can be stored in, for example, storage regions of the personal computer 11 illustrated in FIG. 1 and a server (not illustrated) connected via a network.

It is preferable that the made-to-order system of the present invention further include output device for outputting the blend ratio generated by the blend ratio setting apparatus in association with the customer ID information for identifying the customer. Also with this configuration, in the case where the customer orders the same cosmetic, the cosmetic can be efficiently prepared and supplied without the need for detection of the color of the detection object and the like. For example, an IC card reader/writer and a magnetic-storage card reader/writer can be used as the output device, and a contactless IC card adopting Radio Frequency IDentification (RFID) and a magnetic-storage card can be adopted as the output destination.

It is preferable that the made-to-order system of the present invention further include transmission apparatus for transmitting the blend ratio generated by the blend ratio setting apparatus in association with the customer ID information for identifying the customer. Also with this configuration, in the case where the customer orders the same cosmetic, the cosmetic can be efficiently prepared and supplied without the need for detection of the color of the detection object and the like. In this case, for example, the blend ratio can be transmitted via e-mail by an application installed on the personal computer illustrated in FIG. 1 to electronic equipment such as a mobile phone, a smart phone, and a personal computer owned by the customer. Moreover, an application that runs on the electronic equipment owned by the customer is created, and the blend ratio can be transmitted via the application to the electronic equipment.

Note that not only the blend ratio generated by the blend ratio setting apparatus but also the production date of a product, the dispatch date thereof, and the like can be stored, output, and transmitted as described above in association with the customer ID information for identifying the customer. Such information can be used to predict the timing at which the customer uses up the product, and an advertising card and the like can be sent to the customer, whereby sales promotion can be achieved. Further, such information can also be used to secure the traceability of the product, and thus is useful in quality control. Further, such information can also be used for production control and marketing.

It is preferable that the made-to-order system of the present invention further include blend ratio analysis apparatus (not illustrated) for analyzing the blend ratio of the prepared cosmetic. Consequently, in the case where the customer orders the same cosmetic, if the customer brings in the previously supplied cosmetic, the same cosmetic can be prepared without the need for detection of the color of the detection object and the like. Moreover, as described in detail in embodiments given later, even in the case of mail-order sales, the cosmetic desired by the customer can be supplied.

The above-mentioned blend ratio analysis may be performed by analyzing the color of the cosmetic or the color of a film or the like to which the cosmetic is applied.

It is preferable that the made-to-order system of the present invention further include: a colorimeter that detects the color of the prepared cosmetic; and blend ratio correction apparatus for correcting the blend ratio generated by the blend ratio setting apparatus on the basis of the difference between the color system value of the color detected by the colorimeter and the color system value of the color that is input by the input apparatus. Consequently, the color reproducibility can be more enhanced. Moreover, even in the case where the number of records in various databases included in the blend ratio setting apparatus is reduced, the color reproducibility can be secured.

For example, a configuration similar to that of the mode in which the blend ratio setting apparatus includes the amount-of-change database can be adopted for the blend ratio correction apparatus. That is, the color system value of the color detected by the colorimeter may be used instead of the color system value of the reference color, and the blend ratio of the color detected by the colorimeter may be used instead of the blend ratio of the reference color. Specifically, the blend ratio correction apparatus can be configured by: an amount-of-change database in which records are stored in the state where the additive amount of each cosmetic composition is associated with the amount of change of each component of the color system value for the additive amount; and an application that generates a blend ratio. The application selects the additive amount of each cosmetic composition and the amount of change of each component of the color system value from the amount-of-change database on the basis of the difference between the color system value of the color that is input to the input apparatus and the color system value of the color detected by the colorimeter, and decides the additive amount of each cosmetic composition. In this way, the application generates a blend ratio.

### [Cosmetic Preparation Apparatus]

Next, a configuration example of the cosmetic preparation apparatus included in the made-to-order system of the present invention is described.

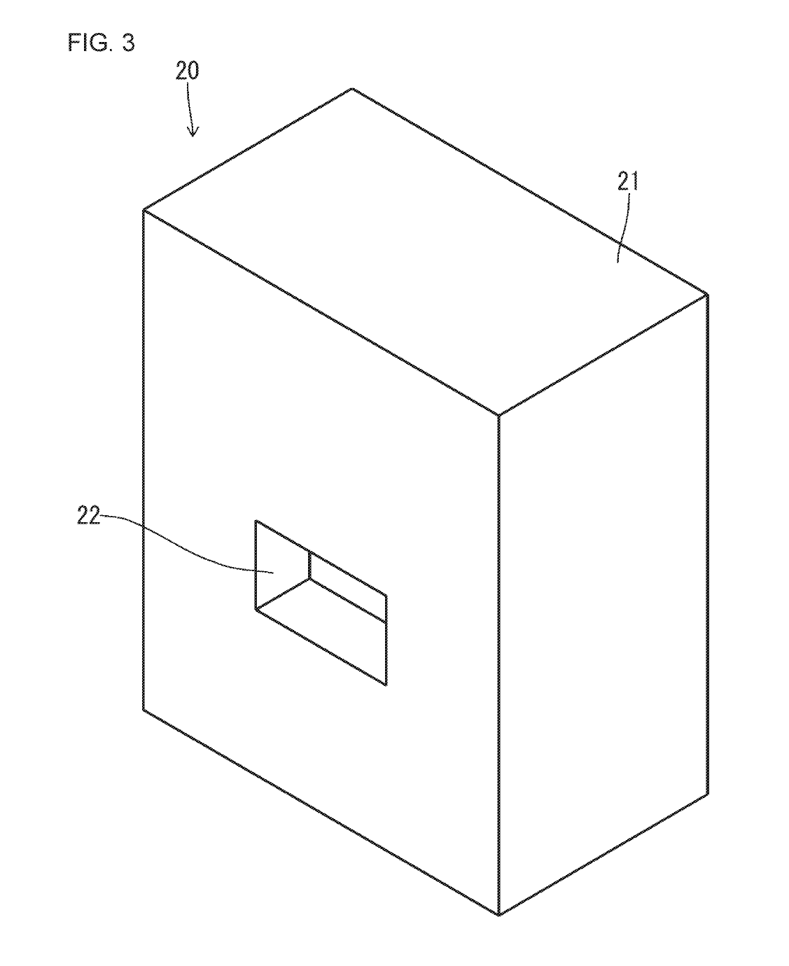

FIG. 3 is a perspective view schematically illustrating an external appearance of the configuration example of the cosmetic preparation apparatus.

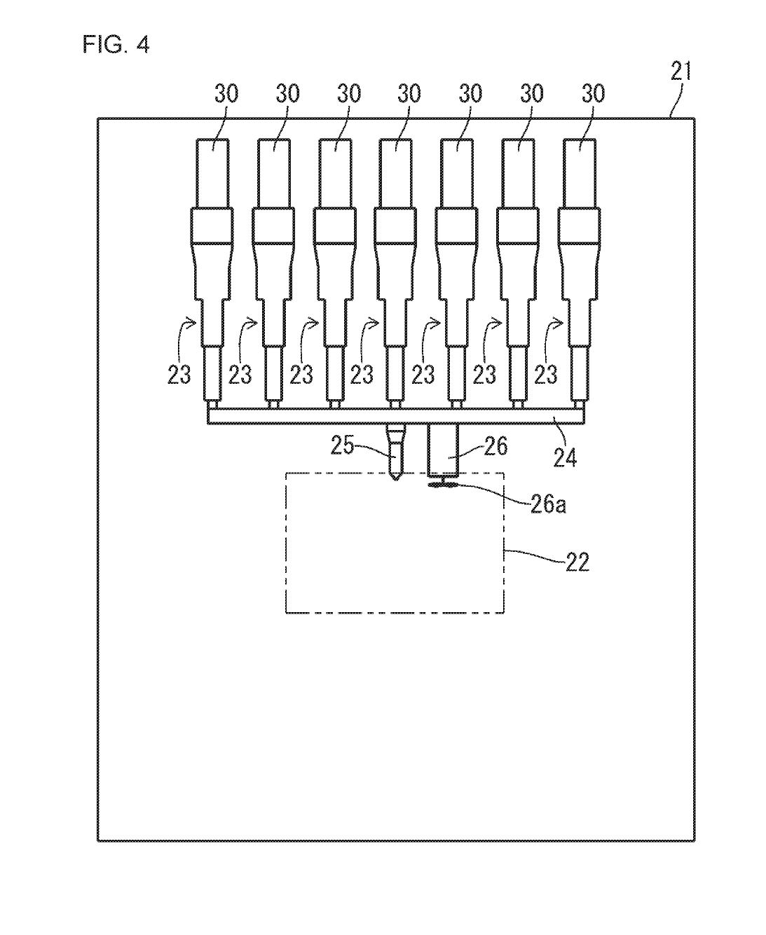

FIG. 4 is a front view schematically illustrating an inside of the configuration example of the cosmetic preparation apparatus.

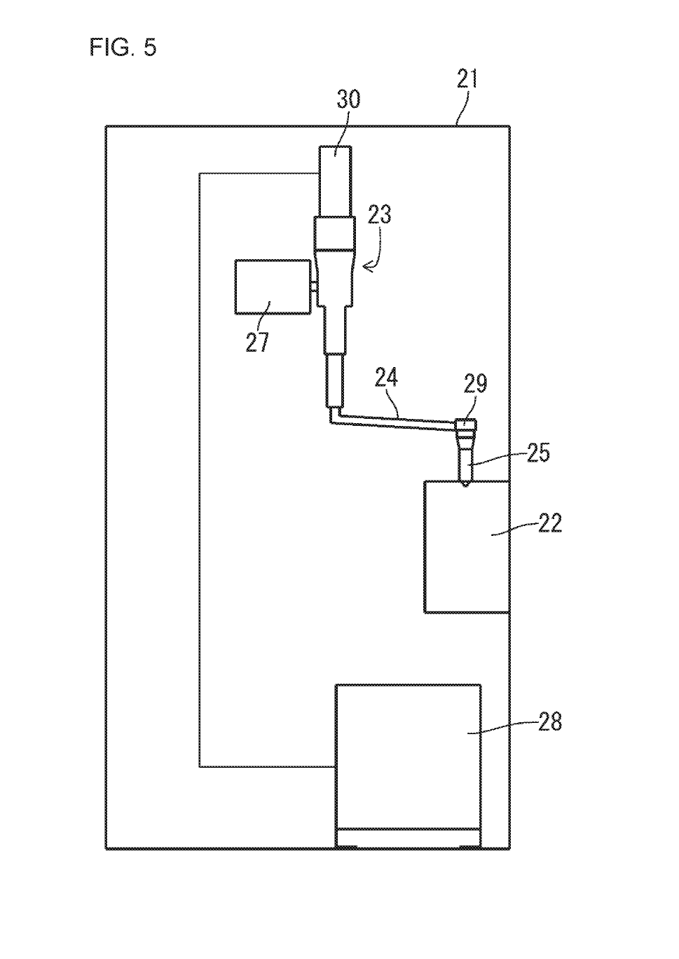

FIG. 5 is a side view schematically illustrating the inside of the configuration example of the cosmetic preparation apparatus.

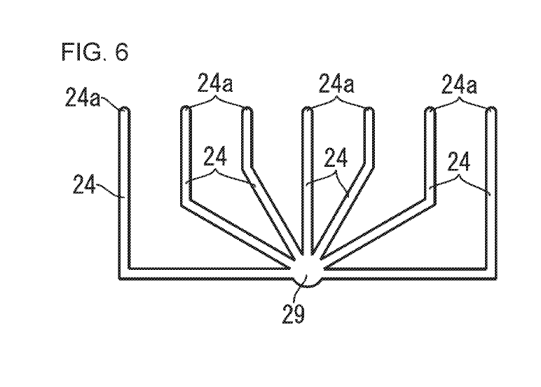

FIG. 6 is a top view schematically illustrating flow paths of cosmetic compositions in the configuration example of the cosmetic preparation apparatus.

In the cosmetic preparation apparatus 20 illustrated in FIGS. 3 to 6, a delivery part 22 is provided to the front of a housing 21 as illustrated in FIG. 3. A container (not illustrated) is put in the delivery part 22, and the container is filled with the prepared cosmetic.

As illustrated in FIGS. 4 and 5, inside of the housing 21, the cosmetic preparation apparatus 20 includes: positive displacement pumps 23 that respectively discharge cosmetic compositions; flow paths 24 that feed the cosmetic compositions respectively discharged from the pumps 23 to a gathering part 29; a nozzle 25 that discharges the cosmetic compositions that have reached the gathering part 29; and a control apparatus 28 that executes operation control of the pumps 23 and the like.

Each positive displacement pump 23 that discharges a cosmetic composition discharges the cosmetic composition in accordance with an operation of a drive device. Each positive displacement pump 23 illustrated in FIGS. 4 and 5 discharges a cosmetic composition stored in a tank 27 in accordance with rotations of a motor 30 as the drive device. The pumps 23, the motors (drive device) 30, and the tanks 27 as described above are provided correspondingly to the kinds of cosmetic compositions necessary to prepare the cosmetic.

The control apparatus 28 calculates the amount of discharge of each cosmetic composition on the basis of the input blend ratio and the amount of order for the cosmetic, and transmits a signal to each motor 30 in accordance with the calculated amount of discharge, to thereby rotate each motor 30. Consequently, each cosmetic composition is discharged by the calculated amount of discharge from the pump 23. The plurality of kinds of cosmetic compositions thus discharged from the pumps 23 respectively flow in the flow paths 24 as illustrated in FIG. 6 from connection parts 24a with discharge ports to the gathering part 29 to join together. The cosmetic compositions that have joined together in the gathering part 29 flow in the nozzle 25 illustrated in FIGS. 4 and 5, and fill the container (not illustrated).

In the cosmetic preparation apparatus 20 illustrated in FIGS. 4 and 5, a stirrer 26 is arranged next to the nozzle 25. The stirrer 26 includes a stirrer blade 26a that is driven and rotated by a drive device (not illustrated), and the stirrer blade 26a can move up and down. Hence, when the stirrer blade 26a is moved down and rotated, the cosmetic compositions that fill the container at a predetermined blend ratio can be mixed. In this way, the cosmetic preparation apparatus 20 prepares the cosmetic from the plurality of cosmetic compositions.

In the made-to-order system of the present invention, for example, diaphragm pumps can be used as the positive displacement pumps 23 of the cosmetic preparation apparatus, but it is preferable to use uniaxial eccentric screw pumps thereas.

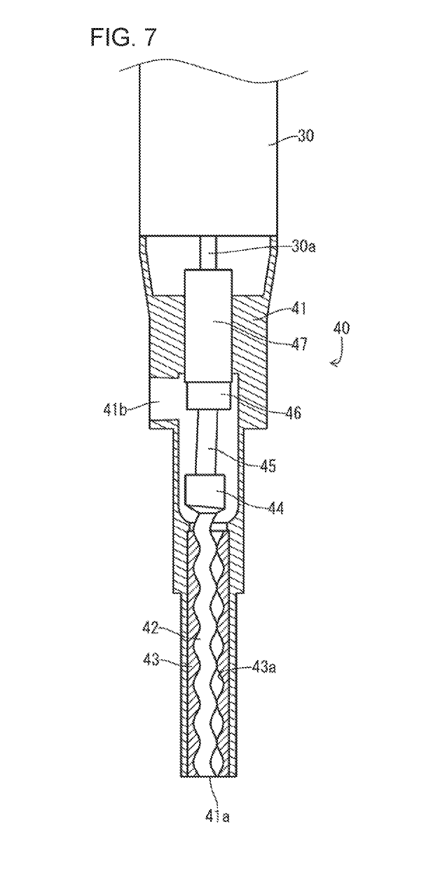

FIG. 7 is a cross-sectional view schematically illustrating a configuration example of the uniaxial eccentric screw pump preferably used as each pump of the cosmetic preparation apparatus. A uniaxial eccentric screw pump 40 illustrated in FIG. 7 includes a male-threaded rotor 42 that receives power to eccentrically rotate and a stator 43 having a female-threaded inner circumferential surface. The rotor 42 and the stator 43 as described above are housed inside of a casing 41. The casing 41 is a tubular member made of metal, and a first opening part 41a is provided at one end in the longitudinal direction of the casing 41. The first opening part 41a functions as the discharge port of the uniaxial eccentric screw pump 40, and is connected to each flow path for feeding the cosmetic composition to the gathering part, through a pipe.

Moreover, a second opening part 41b is provided in an outer circumferential portion of the casing 41. The second opening part 41b is communicated with the internal space of the casing 41 in a middle part in the longitudinal direction of the casing 41. The second opening part 41b as described above functions as a suction port of the uniaxial eccentric screw pump 40, and is connected to each tank that stores the cosmetic composition, through a pipe.

The stator 43 is made of an elastic body such as rubber, resin, or the like. An inner hole 43a of the stator 43 is formed into a single-stage or multiple-stage female-thread shape having n starts. In comparison, the rotor 42 is a shaft body made of metal, and is formed into a single-stage or multiple-stage male-thread shape having n−1 starts.

In the uniaxial eccentric screw pump 40 illustrated in FIG. 7, the stator 43 is formed into a multiple-stage female-thread shape having two starts, and the cross-section of the inner hole of the stator 43 is substantially oval at any position in the longitudinal direction. Meanwhile, the rotor 42 is formed into an eccentric male-thread shape having one start, and the cross-section of the rotor 42 is substantially perfectly circular at any position in the longitudinal direction. The rotor 42 is inserted through the inner hole 43a formed in the stator 43, and is made freely eccentrically rotatable inside of the inner hole 43a.

In order to make the rotor 42 eccentrically rotatable, the rotor 42 is coupled to a rod 45 through a first universal joint 44, and the rod 45 is coupled to a drive shaft 47 through a second universal joint 46. The drive shaft 47 is rotatably held by the casing 41 in the state where a gap with the casing 41 is sealed, although detailed description is omitted. The drive shaft 47 as described above is coupled to a main shaft 30a of the motor 30. Hence, along with rotations of the main shaft 30a caused by an operation of the motor 30, the drive shaft 47 rotates, and the rotor 42 coupled thereto through the universal joints and the rod 45 eccentrically rotates.

If the rotor 42 is rotated inside of the inner hole 43a of the stator 43, the space partitioned by the rotor 42 and the inner hole 43a of the stator moves in the longitudinal direction of the stator 43 while rotating inside of the stator 43. Hence, if the rotor 42 is rotated, a fluid can be suctioned from one end side of the stator 43, and the suctioned fluid can be fed and discharged toward another end side of the stator 43. In the uniaxial eccentric screw pump 40 illustrated in FIG. 7, if the rotor 42 is rotated in the forward direction, the cosmetic composition suctioned from the second opening part 41b can be fed under pressure, and can be discharged from the first opening part 41a.

By controlling rotations of the motor that rotationally drives the uniaxial eccentric screw pump as described above, the amount of discharge of the cosmetic composition can be freely and accurately changed. Hence, if the positive displacement pumps of the cosmetic preparation apparatus are the uniaxial eccentric screw pumps, the quality of cosmetics can be enhanced and variations in quality can be reduced compared with the case of using the diaphragm pumps. Moreover, if the positive displacement pumps are the uniaxial eccentric screw pumps, the quality of cosmetics can be enhanced and variations in quality can be reduced compared with the case of using rotary pumps and piston pumps.

Here, in the case where cosmetics having different blend ratios are successively prepared, cosmetic compositions that remain in the gathering part 29 and the like at the time of the previous preparation may mix into the cosmetic at the time of the subsequent preparation and may change the blend ratio. Hence, it is preferable that, in the made-to-order system of the present invention, the cosmetic preparation apparatus further include a washing apparatus that washes portions that contact with the plurality of kinds of cosmetic compositions, such as the gathering part 29, the nozzle 25, and the stirrer blade 26a of the stirrer. Consequently, if washing is performed using the washing apparatus between the previous preparation and the subsequent preparation, the cosmetic compositions that remain at the time of the previous preparation can be removed, and thus can be prevented from mixing into the cosmetic at the time of the subsequent preparation.

The washing apparatus can be configured by, for example: a washing liquid storage tank; a washing liquid supply pump (washing liquid supply device) that suctions a washing liquid in the tank and discharges the washing liquid; washing liquid supply flow paths that supply the washing liquid discharged from the washing liquid supply pump to washing target portions such as the gathering part 29; washing liquid release flow paths that release the washing liquid that has been used for washing, from the washing target portions; and a collection tank that collects the released washing liquid. For example, water, a solvent, or a liquid containing a washing agent can be used as the washing liquid. It is more preferable that the washing apparatus further include release promotion device such as an air injection apparatus (not illustrated), in order to reliably release the washing liquid after washing.

It is preferable that, in the made-to-order system of the present invention, the cosmetic preparation apparatus further include: a container stock part that stocks therein a plurality of kinds of containers having different capacities; and a container supply apparatus that selects any of the containers from the container stock part and supplies the selected container to the delivery part. Consequently, a container having the best capacity can be automatically supplied in accordance with the amount of the cosmetic to be prepared.

It is preferable that, in the made-to-order system of the present invention, the cosmetic preparation apparatus further include a temperature regulation apparatus (not illustrated) that keeps the temperature of each cosmetic composition constant. Consequently, even if the temperature of the installation place of the cosmetic preparation apparatus changes, the temperature of each cosmetic composition can be kept constant. As a result, variations in the amount of discharge of each cosmetic composition by the pump can be suppressed. The temperature regulation apparatus can be configured by, for example: a heater that heats each cosmetic composition stored in the tank; a cooler that cools each cosmetic composition stored in the tank; a thermometer that measures the temperature of each cosmetic composition stored in the tank; and a controller that changes outputs of the heater and the cooler in accordance with the temperature measured by the thermometer and controls the temperature of each stored cosmetic composition to an input value.

Moreover, not only the tank but also portions such as the stator, the casing, the nozzle or the like of the pump may be heated or cooled using a heating water jacket or a cooling water jacket.

In the made-to-order system of the present invention, the cosmetic preparation apparatus mixes cosmetic compositions respectively discharged by means of the pumps, and the stirrer used for the mixing is not limited to the stirrer including the stirrer blade. For example, a container filled with a plurality of kinds of cosmetic compositions may be vibrated or rotated, whereby the cosmetic compositions may be stirred and mixed in a liquid contactless manner. Alternatively, a kneader may be provided in addition to the stirrer.

The cosmetic preparation apparatus illustrated in FIGS. 3 to 6 causes a plurality of kinds of cosmetic compositions respectively discharged by means of the plurality of pumps 23 to flow in the flow paths 24 and join together in the gathering part 29, and fills a container with the cosmetic compositions that have joined together, using the one nozzle 25, but another mode can also be adopted. For example, a separate mode can be adopted, in which a nozzle is provided for each pump (cosmetic composition) and a flow path that connects each nozzle and each pump is provided. In this case, the plurality of kinds of cosmetic compositions do not join together in the flow paths extending from the respective pumps to the nozzle, but are mixed in the container.

If the separate mode and the stirring in the liquid contactless manner as described above are adopted, the cosmetic preparation apparatus does not require the above-mentioned washing apparatus. As a result, the equipment cost can be reduced, and the productivity can be enhanced.

In the made-to-order system of the present invention, the cosmetic preparation apparatus can start and end discharging of cosmetic compositions simultaneously by the plurality of pumps to thereby prepare a cosmetic, in the state where the cosmetic preparation apparatus changes the rotational speed of each motor to thereby adjust the amount of discharge (discharge speed) per unit time of each pump as described above. Not limited to this mode, for example, a mode in which the plurality of pumps discharge the cosmetic compositions in order can also be adopted.

### [Basic Test]

In the present test, liquid pigments were respectively discharged into a container by means of two dispensers and were mixed, and the color of the mixture liquid (sample) was detected by the colorimeter. The two dispensers were both provided with uniaxial eccentric screw pumps as the positive displacement pumps. Each of the uniaxial eccentric screw pumps was driven by a motor whose rotational speed was set to 60 min⁻¹, and the amount of discharge (mL) thereof was changed by changing the operation time.

The first dispenser was caused to discharge a red pigment, and the second dispenser was caused to discharge a yellow pigment. In the present test, Cases 1 to 6 were provided, and the operation time of the first dispenser and the operation time of the second dispenser were changed while the sum of the operation times of the two dispensers was kept 5 seconds. Specifically, for Cases 1 to 6, the operation time of the first dispenser and the operation time of the second dispenser were set such that the ratio of the yellow pigment became higher as the case number became larger. The amount of the obtained mixture liquid was 1.15 mL for all the cases.

Five samples were made in each case, and the average value was calculated for each component of the color system value of the L*a*b* color model from results of detection on the five samples. Moreover, the color differences were calculated using the average color system value of each case and the respective color system values of the samples, and the average value was obtained from the respective color differences of the samples. The average value of the respective color differences of the samples indicates variations in sample color. Further, in order to assist understanding of the relation between the additive amount of the cosmetic composition and the amount of change of each component of the color system value, the color differences between the cases were calculated using the respective average color system values of the cases.

Table 1 shows, for each case, the operation time of the first dispenser, the operation time of the second dispenser, the average value of the L* component, the average value of the a* component, the average value of the b* component, and the average value of the respective color differences of the samples.

TABLE 1

| | Operation Times of | | | | | Average Value of |
|---|---|---|---|---|---|---|
| | Dispensers | | Average | Average | Average | Respective Color |
| | [seconds] | | Value of L* | Value of a* | Value of b* | Differences of |
| No. | First | Second | Component | Component | Component | Samples |
| Case 1 | 5 | 0 | 37.734 | 33.738 | 18.636 | 0.293 |
| Case 2 | 4 | 1 | 39.148 | 34.386 | 20.412 | 0.116 |
| Case 3 | 3 | 2 | 40.912 | 34.370 | 22.784 | 0.356 |
| Case 4 | 2 | 3 | 43.412 | 32.836 | 26.348 | 0.297 |
| Case 5 | 1 | 4 | 47.444 | 28.084 | 32.408 | 0.358 |
| Case 6 | 0 | 5 | 66.954 | 1.076 | 63.430 | 0.542 |

Here, if a color difference ΔE is 0.4 to 0.8, the color difference ΔE corresponds to an AAA-class allowable difference, and the AAA-class allowable difference is the limit at which a strict standard for an allowable color difference can be set, in terms of the reproducibility of visual recognition and determination. Moreover, if the color difference ΔE is 0.2 to 0.4, the color difference ΔE corresponds to a discrimination boundary. In the discrimination boundary, color difference is within the range of the reproduction accuracy of a sufficiently adjusted colorimetric instrument, and it is the limit at which a trained person can discriminate with reproducibility.

From the test results in Table 1, the average value of the color differences in each case corresponded to the AAA-class allowable difference or the discrimination boundary. That is, the respective color differences of the samples in each case were sufficiently small, and it could be confirmed that the color could be reproduced with high accuracy.

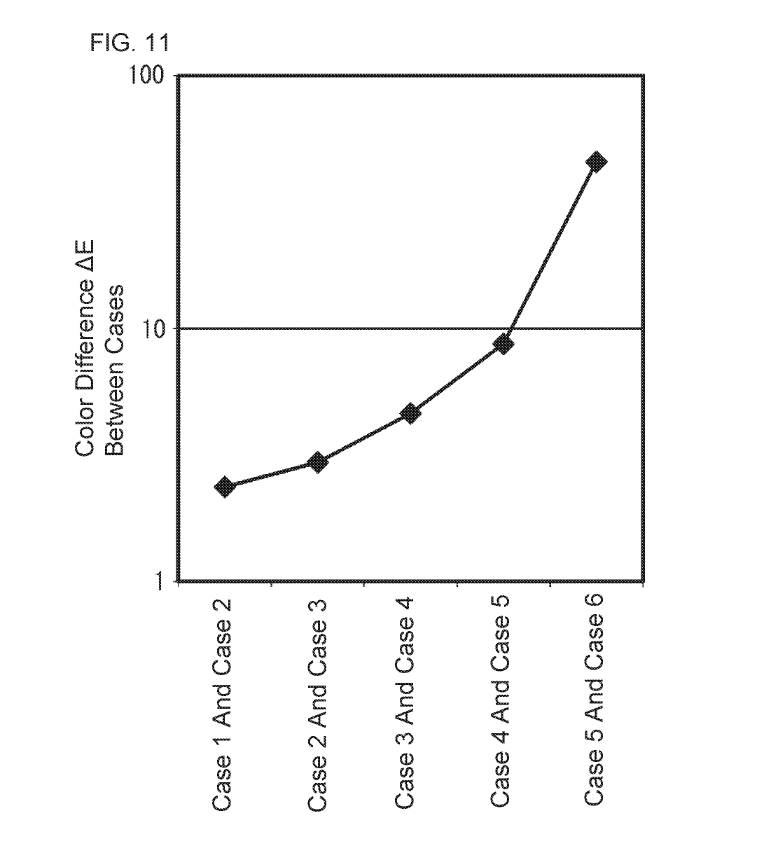

FIG. 11 is a diagram illustrating the color differences ΔE between the cases. From FIG. 11, under the conditions of the present test, the color difference between Case 2 and Case 3 was larger than the color difference between Case 1 and Case 2. In a generalized form, the color difference between Case (n+1) and Case (n+2) was larger than the color difference between Case (n) and Case (n+1). Here, it is assumed that n is a natural number of 1 to 4. From these facts, it could be confirmed that the additive amount of the cosmetic composition and the amount of change of the color system value were relevant to each other.

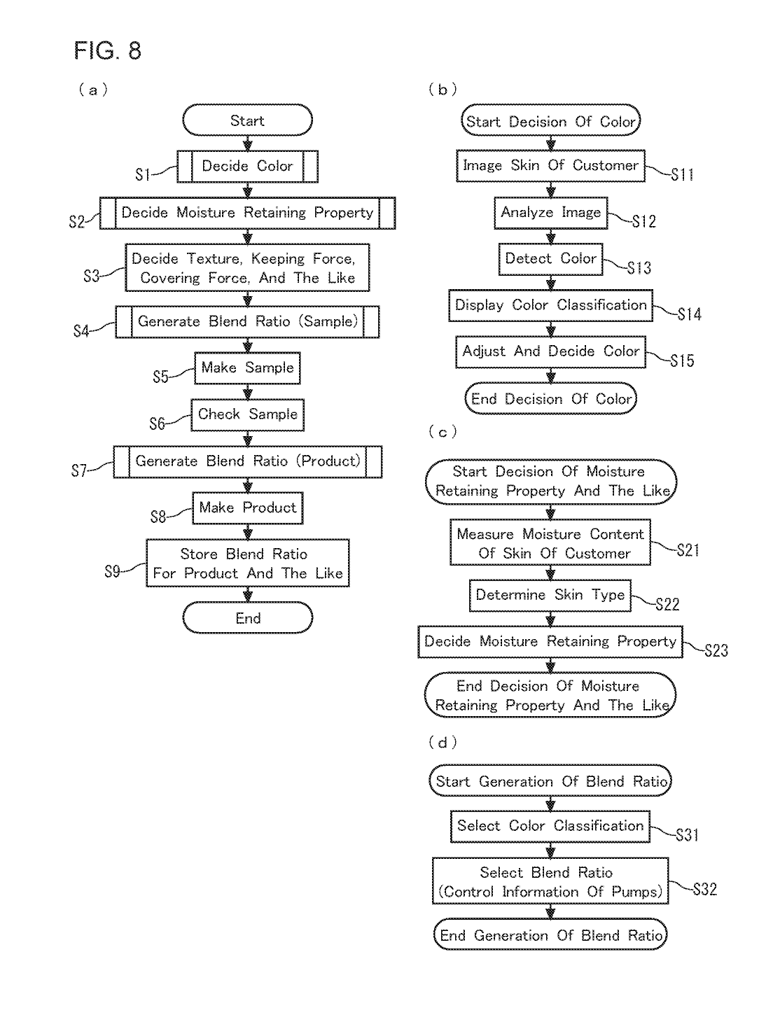

The above-mentioned made-to-order system of the present invention can be applied to various cosmetics and various made-to-order modes. Hereinafter, embodiments of the made-to-order system of the present invention are described. In Embodiment 1, description is given with reference to a processing flow example in FIG. 8 to be described below.

FIG. 8 is a diagram illustrating the processing flow example of the made-to-order system for cosmetics according to the present invention in which FIG. 8(a) illustrates a main process, FIG. 8(b) illustrates a process of deciding a color, FIG. 8(c) illustrates a process of deciding a moisture retaining property and the like, and FIG. 8(d) illustrates a process of generating a blend ratio. S1 to S9, S11 to S15, S21 to S23, S31, and S32 in FIG. 8 each indicate a processing step.

### Embodiment 1

### Embodiment in which Foundations are Sold in Shops

The made-to-order system illustrated in FIG. 1 can be used for, for example, the case where foundations are sold in shops such as a cosmetic sales agency, a cosmetic sales floor of a department store, a drug store, and a convenience store.

### (1) Decision of Color (S1)

When a foundation is sold, the salesperson operates the color detection apparatus 12 to thereby detect the color of the skin of the customer (S11 to S13). The salesperson decides the color of the cosmetic on the basis of the detected color of the skin (S15). On this occasion, the salesperson adjusts the color of the cosmetic considering the preference of the customer and the like, as needed. Alternatively, the customer may select another color classification that more suits his/her preference, with reference to the color classification that is displayed on the display by the color classification display apparatus. Alternatively, the salesperson may recommend, for the customer, another color classification that more conforms to the skin, the preference, and the like of the customer, with reference to the color classification that is displayed on the display by the color classification display apparatus (S14). If the above-mentioned cosmetic simulation apparatus and the above-mentioned light source simulation apparatus are also used as needed, the color of the cosmetic can be more efficiently decided.

### (2) Decision of Moisture Retaining Property and the Like (S2 and S3)

Subsequently, the salesperson operates the skin type determination apparatus 13 to thereby determine the skin type of the customer, and decides the moisture retaining property of the cosmetic on the basis of the determined skin type (S21 to S23). On this occasion, the salesperson adjusts the moisture retaining property of the cosmetic considering the preference of the customer and the like, as needed. Moreover, the salesperson listens to requests concerning a texture such as a pearly texture or a matte texture, a keeping force, a covering force, and the like, from the customer, and decides the texture, the keeping force, and the covering force of the cosmetic (S3).

### (3) Generation of Blend Ratio for Sample (S4)

The salesperson inputs the color, the moisture retaining property, the texture, the keeping force, and the covering force of the cosmetic thus determined, to the blend ratio setting apparatus 14, and the blend ratio setting apparatus 14 generates a blend ratio (a blend ratio for a sample) for preparing the cosmetic having the input color and the like from a plurality of kinds of cosmetic compositions.

Specifically, the blend ratio setting apparatus 14 selects a color classification within a usable range from the color classification database with reference to the input color (S31). Moreover, the blend ratio setting apparatus 14 selects parameters for defining the amount of discharge (discharge speed) per unit time of the pump that discharges each cosmetic composition, from the blend ratio database with reference to the selected color classification (S32).

### (4) Making of Sample (S5)

A sample is prepared in a small amount by the cosmetic preparation apparatus 20 on the basis of the blend ratio generated by the blend ratio setting apparatus 14, and a container for the sample is filled with the sample.

### (5) Check of Sample (S6)

The made sample is used for a trial application by the customer or the like. The salesperson adjusts the color, the moisture retaining property, the texture, the keeping force, and the covering force as needed in accordance with the preference of the customer and the requests from the customer.

### (6) Generation of Blend Ratio for Product and Making of Product (S7 and S8)

In the case where the color and the like are not adjusted, the blend ratio for the sample is set as a blend ratio for a product, the cosmetic is prepared in an amount of customer's order by the cosmetic preparation apparatus 20, and a container for the product is filled with the prepared cosmetic. Meanwhile, in the case where the color and the like are adjusted, the salesperson inputs the adjusted color, the adjusted moisture retaining property, the adjusted texture, the adjusted keeping force, and the adjusted covering force to the blend ratio setting apparatus 14, and the blend ratio setting apparatus 14 newly generates a blend ratio. The newly generated blend ratio is set as the blend ratio for the product, the cosmetic is prepared in the amount of customer's order by the cosmetic preparation apparatus 20, and the container for the product is filled with the prepared cosmetic. On this occasion, label attachment, packing, and the like are performed as appropriate.

### (7) Storing of Blend Ratio for Product and the Like (S9)

The blend ratio for the product is stored, or otherwise appropriately handled, by the above-mentioned storage device, the above-mentioned output device, or the above-mentioned transmission apparatus in association with the customer ID information for identifying the customer. In addition, production information such as a production date and dispatch information such as a dispatch date are stored, or otherwise appropriately handled, in association with the customer ID information.

### Embodiment 2

### Embodiment in which Concealers are Sold in Shops

### (1) Decision of Color

When a concealer is sold, the salesperson operates the color detection apparatus 12 to thereby detect the color of the skin of the customer and the color of a use target portion (for example, a blemish and dark circles under eyes) of the concealer. The salesperson decides the color of the concealer on the basis of the detected color of the skin and the detected color of the use target portion of the concealer. On this occasion, if the salesperson selects the color suitable for the detected color of the skin of the customer and the detected color of the use target portion of the concealer using the above-mentioned color selection apparatus, the salesperson can efficiently decide the color of the concealer. The salesperson adjusts the color of the concealer considering the preference of the customer and the like, as needed. Alternatively, the customer may select another color classification that more suits his/her preference, with reference to the color classification that is displayed on the display by the color classification display apparatus. Alternatively, the salesperson may recommend, for the customer, another color classification that more conforms to the skin, the preference, and the like of the customer, with reference to the color classification that is displayed on the display by the color classification display apparatus. If the above-mentioned cosmetic simulation apparatus and the above-mentioned light source simulation apparatus are also used as needed, the color of the cosmetic can be more efficiently decided.

Similarly to Steps (2) to (7) in [Embodiment in which Foundations are sold in Shops] described above, decision of a moisture retaining property and the like, generation of a blend ratio for a sample, making of the sample, check of the sample, generation of a blend ratio for a product and making of the product, and storing of the blend ratio for the product and the like are performed in order.

The present embodiment can be applied to making to order and sales of not only normal concealers for cosmetic use but also, for example, foundations and concealers for medical use for covering up a bruise, a scar, and the like.

### Embodiment 3

### Embodiment in which Lipsticks, Eye Shadows, or Blushers are Sold in Shops

### (1) Decision of Color

When a lipstick, an eye shadow, or a blusher is sold, the salesperson operates the color detection apparatus 12 to thereby detect the color of the skin of the customer. The salesperson decides the color of the cosmetic considering the preference of the customer on the basis of the detected color of the skin. On this occasion, if the above-mentioned color extraction apparatus, the above-mentioned color classification display apparatus, the above-mentioned cosmetic simulation apparatus, and the above-mentioned light source simulation apparatus are also used as needed, the color of the cosmetic can be efficiently decided.

Similarly to Steps (2) to (7) in [Embodiment in which Foundations are sold in Shops] described above, decision of a moisture retaining property and the like, generation of a blend ratio for a sample, making of the sample, check of the sample, generation of a blend ratio for a product and making of the product, and storing of the blend ratio for the product and the like are performed in order.

Note that, in Embodiments 1 to 3, the salesperson assists the customer in each step, but an unattended sales style without the assistance of a salesperson may be adopted. In this case, in Step (5) Check of Sample, the number of check operations may be limited as needed.

### Embodiment 4

### Embodiment in which Cosmetics are Sold by Mail Order

### (1) Decision of Blend Ratio

When a cosmetic is sold by mail order, a sample making kit is sent to the customer. The sample making kit is made of a plurality of kinds of cosmetic compositions. The customer mixes the plurality of kinds of cosmetic compositions to make a sample of a desired color. On this occasion, the customer mixes cosmetic compositions having a texture, a keeping force, and a covering force as needed.

### (2) Sending Back of Sample

The customer sends back the made sample, and the blend ratio of the sent-back sample is analyzed and determined by the blend ratio analysis apparatus.

### (3) Making of Product

On the basis of the blend ratio obtained by the blend ratio analysis apparatus, the cosmetic is prepared in an amount of customer's order by the cosmetic preparation apparatus 20, and a container for the product is filled with the prepared cosmetic. On this occasion, label attachment, packing, and the like are performed as appropriate. The product thus made is sent to the customer.

### (4) Storing of Blend Ratio for Product and the Like

The blend ratio is stored, or otherwise appropriately handled, by the above-mentioned storage device or the above-mentioned transmission apparatus in association with the customer ID information for identifying the customer. In addition, production information such as a production date and dispatch information such as a dispatch date are stored, or otherwise appropriately handled, in association with the customer ID information.

If the made-to-order system of the present invention includes the blend ratio analysis apparatus as described above, the made-to-order system can supply the cosmetic desired by the customer even in the case of mail-order sales. In this case, the customer does not need to visit a shop. Moreover, because the customer decides a blend ratio by himself/herself, there is no temporal constraint. Moreover, because the customer can check a sample made by himself/herself under various environments in which illumination and the like are different, the customer can make a sample closer to the cosmetic desired by the customer.

### Embodiment 5

### Embodiment in which Customer Prepares Cosmetics Each Time

In addition to the case where the cosmetic is sold to the customer in a shop or by mail order as described above, the made-to-order system of the present invention can also be applied to the case where the customer himself/herself prepares the cosmetic used in his/her home, workplace, or the like each time. In the present embodiment, the customer performs procedures substantially similar to those in [Embodiment in which Foundations are sold in Shops], [Embodiment in which Concealers are sold in Shops], or [Embodiment in which Lipsticks, Eye Shadows, or Blushers are sold in Shops] described above, in his/her home, workplace, or the like without the assistance of a salesperson. In this case, processes such as filling a container for the product, label attachment, and packing in Step (6) Generation of Blend Ratio for Product and Making of Product may be omitted as needed.

The present embodiment can be preferably carried out in the case of on-the-job use by makeup artists, hairdressers, theatrical performers, and other performers. Moreover, in the case of theatrical makeup and the like, cosmetics under a light source different from normal light sources are necessary in many cases, and hence the cosmetic simulation apparatus and the light source simulation apparatus are particularly effective.

### Embodiment 6

### Embodiment in which Sample Making Kit is Used for Color Decision

In the present embodiment, a sample making kit is used similarly to Embodiment 4, but the sample making kit is used for only color decision, and a moisture retaining property and the like are decided without using the sample making kit.

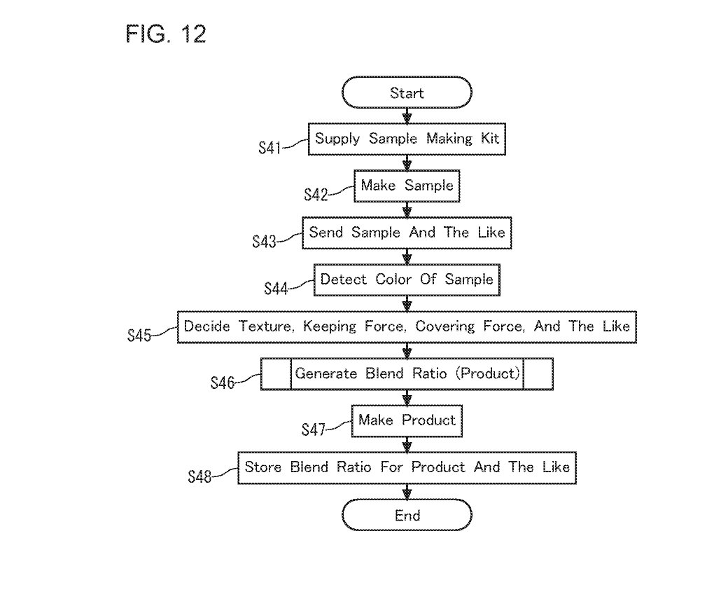

FIG. 12 is a diagram illustrating a processing flow example in the case where the sample making kit is used for color decision. S41 to S48 in FIG. 12 each indicate a processing step.

### (1) Color Decision (S41 to S44)

For color decision, the sample making kit as illustrated in FIG. 9 is supplied to the customer (S41). The sample making kit may be supplied by, for example, sending in response to the order from the customer or distributing in sales agencies.

The customer mixes cosmetic compositions in the sample making kit to make a sample of a desired color (S42). For example, in the case where the cosmetic is a foundation, the customer may mix the cosmetic compositions on the back of his/her hand to thereby make the sample of the desired color. The customer can make the sample while, for example, receiving advice and assistance from a salesperson in a sales agency. Moreover, the customer can make the sample with reference to instructions in his/her home or the like.

The made sample is sent to a factory by the customer, for example, in the state where the sample is housed in a container (S43). Alternatively, the made sample may be handed over to the sales agency. On this occasion, part of the made sample may be attached to a film, and the sample may be sent or handed over together with the film. Instead of the made sample, the balance of each of the plurality of kinds of cosmetic compositions may be sent or handed over together with the pallet.

In the factory, a worker operates the color detection apparatus (for example, a colorimeter) to thereby detect the color of the made sample (S44). Meanwhile, in the case of using the balance of each of the plurality of kinds of cosmetic compositions, the worker measures the amount of the balance of each cosmetic composition using the balance analysis apparatus, and obtains the color of the cosmetic sample that is prepared such that the balance of each cosmetic composition becomes this amount. This processing step may be performed by the salesperson in the sales agency. On this occasion, the salesperson may display the detected color using the display device, for the customer.

### (2) Decision of Moisture Retaining Property and the Like (S45)

Similarly to Step (2) in [Embodiment in which Foundations are sold in Shops] described above, a moisture retaining property and the like are decided. Alternatively, the customer may decide the moisture retaining property and the like using, for example, a wizard screen provided on the Internet, without receiving advice from the salesperson.

### (3) Generation of Blend Ratio for Sample (S46)

The salesperson or the worker inputs the color, the moisture retaining property, the texture, the keeping force, and the covering force of the cosmetic thus determined, to the blend ratio setting apparatus 14, and the blend ratio setting apparatus 14 generates a blend ratio for preparing the cosmetic having the input color and the like from the plurality of kinds of cosmetic compositions.

### (4) Making of Product (S47)

A product is prepared by the cosmetic preparation apparatus 20 on the basis of the blend ratio generated by the blend ratio setting apparatus 14, and a container for the product is filled with the prepared product. On this occasion, label attachment, packing, and the like are performed as appropriate.

### (5) Storing of Blend Ratio for Product and the Like (S48)

Similarly to Step (7) in [Embodiment in which Foundations are sold in Shops] described above, the blend ratio for the product and the like are stored.

Note that the above-mentioned embodiments are described as the made-to-order system for cosmetics primarily intended for cosmetic sales, but the system is not limited thereto, and can be used as a preparation system for cosmetics in the case where the system is not intended for cosmetic sales. The preparation system for cosmetics of the present invention can be used for, for example, preparation in development and the like of cosmetics. A configuration and preferable aspects similar to those of the made-to-order system for cosmetics of the present invention can be adopted for the preparation system for cosmetics of the present invention. In addition, the following aspects can also be adopted for the preparation system for cosmetics of the present invention.

In the preparation system for cosmetics of the present invention, the detection object can be image data on a photograph obtained by imaging a subject, and the subject can be a human skin or a color sample. In this case, the color detection apparatus includes an image analysis device that analyzes the image data to thereby detect the color of the subject.

In the preparation system for cosmetics of the present invention, the detection object can be image data on a photograph obtained by imaging a color specimen together with a subject, and the subject can be a human skin or a color sample. In this case, the color detection apparatus includes: a color correction device for correcting the color of the image data on the basis of the color of the color specimen in the image data; and an image analysis device that analyzes the image data processed by the color correction device to thereby detect the color of the detection object.

Here, the human skin is not limited to the skin of the customer, and includes the skins of a test subject and the like. The color sample is, for example, a color sample made or prepared by a designer. Sheets to which a paint, a pigment, and the like of desired colors are applied, films to which a paint, a pigment, and the like of desired colors are attached, and a paint, a pigment, and the like of desired colors housed in containers each correspond to such a color sample.

It is preferable that the preparation system for cosmetics of the present invention include balance analysis apparatus for obtaining, from the amount of the balance of each of a plurality of kinds of cosmetic compositions used to make a cosmetic sample, the color of the cosmetic sample that is prepared such that the balance of each cosmetic composition becomes this amount. The cosmetic sample can be made using, for example, the above-mentioned sample making kit. The cosmetic sample is not limitedly made by the customer, and may be made by the designer, the test subject, and the like.

In the preparation system for cosmetics of the present invention, in the case where the detection object is a cosmetic sample or a color sample, a mode in which the color detection apparatus includes a colorimeter that detects the color from the detection object can be adopted.

### INDUSTRIAL APPLICABILITY

As described above, the made-to-order system of the present invention can precisely and efficiently decide the color desired by the customer, and can prevent the color of the prepared cosmetic and the color desired by the customer from being different from each other. Hence, the made-to-order system can be effectively used for made-to-order sales of cosmetics.

The preparation system of the present invention can precisely and efficiently decide the color desired by the worker or the like, and can prevent the color of the prepared cosmetic and the desired color from being different from each other. Hence, the preparation system can be effectively used for preparation in development and the like of cosmetics.

### REFERENCE SIGNS LIST

10: made-to-order system for cosmetics
11: personal computer
12: color detection apparatus
13: skin type determination apparatus
14: blend ratio setting apparatus
20: cosmetic preparation apparatus
21: housing
22: delivery part
23: positive displacement pump
24: flow path
24a: connection part with discharge port
25: nozzle
26: stirrer
26a: stirrer blade
27: tank
28: control apparatus
29: gathering part
30: motor
30a: main shaft of motor
40: uniaxial eccentric screw pump
41: casing
41a: first opening part
41b: second opening part
42: rotor
43: stator
43a: inner hole
44: first universal joint
45: rod
46: second universal joint
47: drive shaft
50: sample making kit
51: pallet
52a to 52f: cosmetic composition

What is claimed is:

1. A made-to-order system for cosmetics comprising:
color detection apparatus for detecting a color of a detection object;
input apparatus for inputting a color of a cosmetic to be prepared;
blend ratio setting apparatus for generating a blend ratio for preparing a cosmetic having the color that is input to the input apparatus, from a plurality of kinds of cosmetic compositions; and
a cosmetic preparation apparatus that prepares the cosmetic by discharging the plurality of kinds of cosmetic compositions by means of respective positive displacement pumps such that the blend ratio generated by the blend ratio setting apparatus is achieved, and mixing the discharged cosmetic compositions.

2. The made-to-order system for cosmetics according to claim 1, further comprising a display device for displaying the color detected by the color detection apparatus.

3. The made-to-order system for cosmetics according to claim 1, wherein
the color detection apparatus includes: an imaging device for imaging a skin of a customer that is the detection object; and an image analysis device that analyzes image data imaged by the imaging device to thereby detect a color of the skin of the customer.

4. The made-to-order system for cosmetics according to claim 1, wherein
the detection object is image data on a photograph obtained by imaging a color specimen together with a skin of a customer, and
the color detection apparatus includes: a color correction device for correcting a color of the image data on the basis of a color of the color specimen in the image data; and an image analysis device that analyzes the image data processed by the color correction device to thereby detect a color of the skin of the customer.

5. The made-to-order system for cosmetics according to claim 1, wherein
the detection object is a photograph obtained by imaging a color specimen together with a skin of a customer, and
the color detection apparatus includes: a scanner that captures the photograph as image data; a color correction device for correcting a color of the image data on the basis of a color of the color specimen in the image data; and an image analysis device that analyzes the image data processed by the color correction device to thereby detect a color of the skin of the customer.

6. The made-to-order system for cosmetics according to claim 1, further comprising balance analysis apparatus for obtaining, from an amount of a balance of each of a plurality of kinds of cosmetic compositions supplied to the customer, a color of a cosmetic sample that is prepared such that the balance of each cosmetic composition becomes this amount.

7. The made-to-order system for cosmetics according to claim 1, wherein
the detection object is a cosmetic sample, and
the color detection apparatus includes a colorimeter that detects a color from the cosmetic sample.

8. The made-to-order system for cosmetics according to claim 1, further comprising a recommended color analysis device for obtaining a recommended color on the basis of the color detected by the color detection apparatus, wherein
the display device further displays the recommended color obtained by the recommended color analysis device.

9. The made-to-order system for cosmetics according to claim 8, wherein
the recommended color analysis device obtains the recommended color considering customer information, fashionable colors, or a season on the basis of the color detected by the color detection apparatus.

10. The made-to-order system for cosmetics according to claim 8, further comprising input assist apparatus for inputting the color detected by the color detection apparatus or the color obtained by the recommended color analysis device, to the input apparatus.

11. The made-to-order system for cosmetics according to claim 1, wherein
the blend ratio setting apparatus includes: an amount-of-change database in which records are stored in the state where an additive amount of each cosmetic composition is associated with an amount of change of each component of a color system value for the additive amount; and an application that generates a blend ratio by selecting the additive amount of each cosmetic composition and the amount of change of each component of the color system value from the amount-of-change database, and deciding the additive amount of each cosmetic composition, on the basis of a difference between a color system value of the color that is input to the input apparatus and a color system value of a reference color.

12. The made-to-order system for cosmetics according to claim 11, wherein
the additive amount of the cosmetic composition in each record of the amount-of-change database changes depending on a separation capability of the positive displacement pump.

13. The made-to-order system for cosmetics according to claim 1, wherein
the positive displacement pumps are uniaxial eccentric screw pumps.

14. A preparation system for cosmetics comprising:
color detection apparatus for detecting a color of a detection object;
input apparatus for inputting a color of a cosmetic to be prepared;
blend ratio setting apparatus for generating a blend ratio for preparing a cosmetic having the color that is input to the input apparatus, from a plurality of kinds of cosmetic compositions; and
a cosmetic preparation apparatus that prepares the cosmetic by discharging the plurality of kinds of cosmetic compositions by means of respective positive displacement pumps such that the blend ratio generated by the blend ratio setting apparatus is achieved, and mixing the discharged cosmetic compositions.

15. The preparation system for cosmetics according to claim 14, wherein
the detection object is image data on a photograph obtained by imaging a subject,
the subject is a human skin or a color sample, and
the color detection apparatus includes an image analysis device that analyzes the image data to thereby detect a color of the subject.

16. The preparation system for cosmetics according to claim 14, wherein
the detection object is image data on a photograph obtained by imaging a color specimen together with a subject,
the subject is a human skin or a color sample, and
the color detection apparatus includes: color correction device for correcting a color of the image data on the basis of a color of the color specimen in the image data; and an image analysis device that analyzes the image data processed by the color correction device to thereby detect a color of the detection object.

17. The preparation system for cosmetics according to claim 14, further comprising balance analysis apparatus for obtaining, from an amount of a balance of each of a plurality of kinds of cosmetic compositions used to make a cosmetic sample, a color of the cosmetic sample that is prepared such that the balance of each cosmetic composition becomes this amount.

18. The preparation system for cosmetics according to claim 14, wherein
the detection object is a cosmetic sample or a color sample, and
the color detection apparatus includes a colorimeter that detects a color from the detection object.

19. The preparation system for cosmetics according to claim 14, wherein
the blend ratio setting apparatus includes: an amount-of-change database in which records are stored in the state where an additive amount of each cosmetic composition is associated with an amount of change of each component of a color system value for the additive amount; and an application that generates a blend ratio by selecting the additive amount of each cosmetic composition and the amount of change of each component of the color system value from the amount-of-change database, and deciding the additive amount of each cosmetic composition, on the basis of a difference between a color system value of the color that is input to the input apparatus and a color system value of a reference color.

20. The preparation system for cosmetics according to claim 19, wherein
the additive amount of the cosmetic composition in each record of the amount-of-change database changes depending on a separation capability of the positive displacement pump.

21. The preparation system for cosmetics according to claim 14, wherein
the positive displacement pumps are uniaxial eccentric screw pumps.
